(19) United States
(12) Patent Application Publication
(10) Pub. No.: US 2024/0331337 A1
(43) Pub. Date: Oct. 3, 2024

(54) METHODS, SYSTEMS, AND STORAGE MEDIUM FOR IMAGE PROCESSING

(71) Applicant: SHANGHAI UNITED IMAGING HEALTHCARE CO., LTD., Shanghai (CN)

(72) Inventors: Yang LYU, Shanghai (CN); Houjiao DAI, Shanghai (CN); Chen XI, Shanghai (CN)

(73) Assignee: SHANGHAI UNITED IMAGING HEALTHCARE CO., LTD., Shanghai (CN)

(21) Appl. No.: 18/622,855

(22) Filed: Mar. 29, 2024

(30) Foreign Application Priority Data
Mar. 29, 2023 (CN) 202310325047.4

(51) Int. Cl. G06V 10/25; G06V 10/80; G06V 10/82

(52) U.S. Cl. CPC G06V 10/25; G06V 10/80; G06V 10/82; G06V 2201/03

(57) ABSTRACT

Embodiments of the present disclosure provide a medical image processing method, system, and storage medium. The method includes determining a plurality of images of regions of interest (ROIs) based on a first image of a subject; determining a plurality of second images based on the plurality of images of the ROIs and image processing models corresponding to the plurality of images of the ROIs; and performing a fusion operation based on the plurality of second images to obtain a target image.

### CROSS REFERENCE TO RELATED APPLICATIONS

The present disclosure claims priority to Chinese application No. 202310325047.4, filed Mar. 29, 2023, the entire contents of which are incorporated herein by reference.

### TECHNICAL FIELD

The present disclosure relates to the field of image processing technology, and in particular, to an image processing method, system, and storage medium based one or more trained machine learning model.

### BACKGROUND

With the rapid development of neural networks, neural networks have demonstrated far superior results in the field of computer vision than those of traditional techniques. Therefore, how to optimize a medical image using a neural network (e.g., a convolutional neural network) has become an important research topic. For example, the neural network can be used to optimize a medical image of a subject to obtain an optimized medical image. However, the traditional techniques of optimizing the medical image using the neural network only ensure the overall quality of the optimized medical image, and does not ensure the local quality of individual organ regions in the medical image.

Therefore, it is desired to provide a method, a system, and storage medium for image processing capable of using the neural network to achieve overall optimization and/or local optimization of a medical image, and to improve the overall quality and/or local quality of the medical image.

### SUMMARY

One or more embodiments of the present disclosure provide an image processing method. The method may include determining one or more images of regions of interest (ROIs) based on a first image of a subject. Each image of the one or more images of one or more ROIs may represent one of the one or more ROIs. The method may also include determining, based on the one or more images of the one or more ROIs, one or more second images. Each of the one or more second images may correspond to one of the images of the one or more ROIs and represent one of the one or more ROIs in the one of the images of the one or more ROIs, and be determined based on one or more trained machine learning models for image processing corresponding to the one of the images of the one or more ROIs, wherein the image quality of the second image is higher than the image quality of the image of the ROI. The method may further include obtaining a target image of the subject based on the one or more second images.

One or more embodiments of the present disclosure provide an image processing system. The system may comprise a storage device storing a computer instruction and a processor connected to the storage device, and when the computer instruction is executed, the processor may cause the system to execute: determine one or more images of one or more ROIs based on a first image of a subject, each of the one or more images of one or more ROIs representing one of the one or more ROIs; determine, based on the one or more images of the one or more ROIs, one or more second images, each of which may correspond to one of the one or more images of the one or more ROIs, and may be determined based one or more trained machine learning models for image processing corresponding to the one of the one or more images of the one or more ROIs, wherein the image quality of the second image be higher than the image quality of the image of the ROI; and obtain a target image of the subject based on the one or more second images.

In some embodiments, wherein different images of ROIs in the one or more images of one or more ROIs correspond to different regions in the first image, and the different regions partially overlap or the different regions do not overlap.

In some embodiments, wherein different images of ROIs in the one or more images of the one or more ROIs are processed by different trained machine learning models, the different trained machine learning models corresponding to different optimization directions.

In some embodiments, wherein the processor further may cause the system to execute: determine a first training dataset based on a plurality of pairs of sample images, each pair of the plurality of pairs of sample images including a sample first image and a sample second image of a sample subject, wherein the image quality of the sample second image is higher than the image quality of the sample first image; and determine the trained machine learning model by training the preliminary machine learning model based on the first training dataset.

In some embodiments, wherein the processor further may cause the system to execute: determine at least one of the one or more trained machine learning models corresponding to the one of the one or more images of the one or more ROIs based on at least one of user information or a feature of the ROI, wherein the feature of the ROI may be determined based on the one of the one or more images of the one or more ROIs.

In some embodiments, wherein the processor may further cause the system to execute: determine an optimization parameter of at least one of the one or more trained machine learning models corresponding to the one of the one or more images of the one or more ROIs based on at least one of the user information or the feature of the ROI, the optimization parameter being used to determine training dataset for training the at least one of the one or more trained machine learning models corresponding to the one of the one or more images of the one or more ROIs and/or as an input to the at least one of the one or more trained machine learning models corresponding to the one of the one or more images of the one or more ROIs.

In some embodiments, wherein the processor may further cause the system to execute: for the one of the images of the ROIs; determine a plurality of third images corresponding to the one of the one or more images of the one or more ROIs based on the one or more trained machine learning models, different third images in the plurality of third images corresponding to different optimization directions; and determine a second image corresponding to the one of the one or more images of one or more ROIs based on the plurality of third images.

In some embodiments, one of the one or more trained machine learning model may include at least one of a U-Net model, a V-Net model, or a U-Net++ model.

In some embodiments, wherein the user information includes at least one of a user's primary treatment direction or the user's requirement for the image, and the feature of the ROI includes a type of the ROI, a parameter of an image or surrounding tissue information of the ROI.

In some embodiments, wherein the processor may further cause the system to execute: in response to determining that a target ROI exists in the target image, adjust the one or more trained machine learning models to obtain one or more updated trained machine learning models; determine, based on the images of the one or more ROIs, one or more optimized images, each of the plurality of optimized images corresponding to one of the images of the one or more ROIs and being determined based on the one or more updated trained machine learning models; obtain an updated target image based on the one or more optimized images; wherein the image quality of a portion of the target image corresponding to the target ROI does not satisfy an image quality condition.

In some embodiments, wherein the processor may further cause the system to execute: adjust an initial image reconstruction parameter to obtain a target image reconstruction parameter; reconstructing scanned data of the target ROI to obtain a fourth image based on the target image reconstruction parameter, and reconstructing target scanned data of the target ROI to obtain a fifth image based on the target image reconstruction parameter, wherein the image quality of the fourth image is higher than the image quality of the fifth image; obtain the one or more updated trained machine learning models, based on the fourth image and the fifth image, by updating the one or more trained machine learning model corresponding to the target ROI.

In some embodiments, wherein the processor may further cause the system to execute: change a type of the one or more trained machine learning models corresponding to the target ROI; and train the one or more trained machine learning models whose type changed based on the fourth image and the fifth image to obtain the one or more updated trained machine learning models.

In some embodiments, wherein the processor may further cause the system to execute: determine the target image by performing a fusion process on the one or more second images and the first image based on fusion coefficients each of which corresponding to one of the one or more second images.

In some embodiments, the processor may further cause the system to execute: determine the target image by performing the fusion operation on the one or more second images and the first image based on fusion coefficients.

In some embodiments, the processor may further cause the system to execute: determine the target image by performing the fusion operation on the one or more second images and the first image through a third trained machine learning model.

One or more embodiments of the present disclosure further provide a computer-readable storage medium. The storage medium stores a computer instruction, and when the computer instruction is executed by a processor, the image processing method may be implemented. The method includes: determining one or more images of one or more ROIs based on a first image of a subject; determining, based on the one or more images of the one or more ROIs, one or more second images, each of the one or more second images corresponds to one of the images of the one or more ROIs, and may be determined based one or more trained machine learning models for image processing corresponding to the one of the one or more images of the one or more ROIs, wherein the image quality of the second image be higher than the image quality of the image of the ROI; and obtaining a target image of the subject based on the one or more second images.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary application scenario of an image processing system according to some embodiments of the present disclosure;

FIG. 2 is a schematic diagram illustrating an exemplary computing device on which a particular system may be implemented according to some embodiments of the present disclosure;

FIG. 3 is a schematic diagram illustrating exemplary hardware and software components of the exemplary computing device according to some embodiments of the present disclosure;

FIG. 4 is a flowchart illustrating an exemplary image processing method according to some embodiments of the present disclosure;

FIG. 5 is a schematic diagram illustrating determining an image processing model according to some embodiments of the present disclosure;

FIG. 6 is a flowchart illustrating determining a second image according to some embodiments of the present disclosure;

FIG. 7 is an exemplary schematic illustrating an exemplary image processing model and a fusion model according to some embodiments of the present disclosure;

FIG. 8 is a schematic diagram illustrating an exemplary first image according to some embodiments of the present disclosure;

FIG. 9 is a flowchart illustrating an exemplary a process for determining a target image according to some embodiments of the present disclosure;

FIG. 10 is a schematic diagram illustrating an exemplary bounding box of a target organ according to some embodiments of the present disclosure;

FIG. 11 is a schematic diagram illustrating an exemplary image processing model according to some embodiments of the present disclosure; and

FIG. 12 is a schematic diagram illustrating an exemplary image processing method according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit” and/or “module” as used herein is a way to distinguish between different components, elements, parts, sections or assemblies at different levels. However, the words may be replaced by other expressions if other words accomplish the same purpose.

As shown in the present disclosure and the claims, unless the context clearly suggests an exception, the words “a”, “an”, “one”, “one kind”, and/or “the” do not refer specifically to the singular, but may also include the plural. Generally, the terms “including” and “comprising” suggest only the inclusion of clearly identified steps and elements that do not constitute an exclusive list, and the method or apparatus may also include other steps or elements.

Flowcharts are used in the present disclosure to illustrate operations performed by a system in accordance with embodiments of the present disclosure. It should be appreciated that the preceding or following operations are not necessarily performed in an exact sequence. Instead, steps can be processed in reverse order or simultaneously. Also, it is possible to add other operations to these processes or remove a step or steps from them.

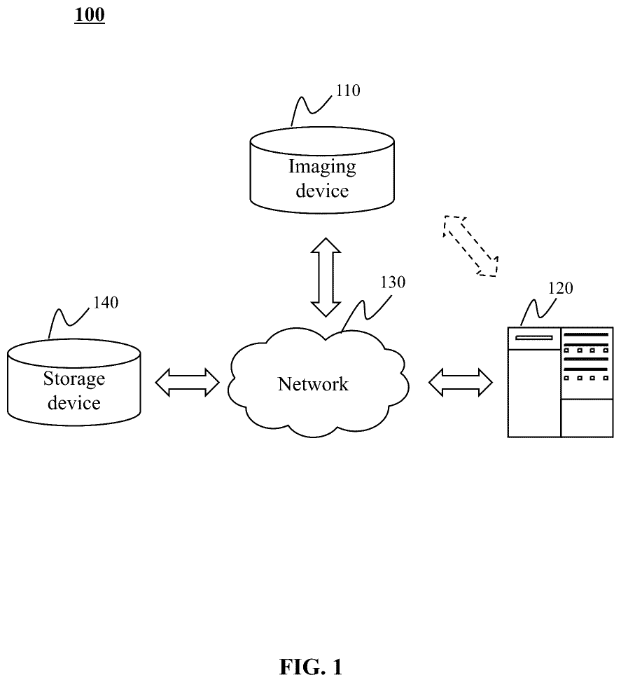

FIG. 1 is a schematic diagram illustrating an exemplary image processing system according to some embodiments of the present disclosure.

As shown in FIG. 1, an image processing system 100 may include an imaging device 110, a processor 120, a network 130, and a storage device 140.

In some embodiments, the imaging device 110, the processor 120, the network 130, and the storage device 140 may be connected to each other and/or in communication via a wireless connection, a wired connection, or a combination thereof. Connections between components of the image processing system may be variable. For example purposes only, the imaging device 110 may be connected to the processor 120 via the network 130 or directly. Further example, the storage device 140 may be connected to the processor 120 either over the network 130 or directly.

The imaging device 110 may be used to generate an image of a subject, for example, a first image. The imaging device 110 may scan a target region of the subject and generate an image. The subject may include biological subjects (e.g., human bodies, animals, etc.), non-biological subjects (e.g., body models), etc. In some embodiments, the target region of the subject may include a particular portion, an organ, and/or a tissue of the subject and other organs and/or tissues within a certain range of the perimeter thereof. For example, the target region of the subject may include the head, the chest, a leg, etc., or any combination thereof.

In some embodiments, the processor 120 and the storage device 140 may be part of the imaging device 110.

In some embodiments, the imaging device 110 may include a medical imaging device, e.g., an X-ray imaging device, a digital radiography (DR), a computed radiography (CR), a digital fluorography (DF), a biochemical immunoanalyzer, a computed tomography (CT) equipment, a magnetic resonance imaging (MR) equipment, a positron emission tomography (PET) imaging equipment, an emission computed tomography (ECT), a digital subtraction angiography (DSA) equipment, electrocardiograms, ultrasound imaging equipment, fluoroscopic imaging equipment, etc., or any combination thereof. In some embodiments, the imaging device 110 may include an industrial imaging device, for example, an optical imaging device, an X-ray digital radiograph (DR) imaging device, an industrial computed tomography (ICT) device, etc. In some embodiments, the imaging device 110 may send a scanned image to the processor 120 and/or the storage device 140 for further processing via the network 130. For example, the imaging device 110 may send the first image of a subject to the processor 120, which may perform processing based on the first image to determine one or more images of one or more ROIs represented in the first image.

The processor 120 may be used to process data and/or information obtained from other devices/components or composition thereof. The processor 120 may execute program instructions based on such data, information, and/or processing results to perform one or more of the functions described in embodiments of the present disclosure. By way of example only, the processor 120 may include, but is not limited to, a central processing unit (CPU), a microprocessor MCU, an application-specific integrated circuit (ASIC), a programmable logic device FPGA, etc., or any combination of the above. For example, the processor 120 may acquire the first image of the subject from the imaging device 110. As another example, the processor 120 may determine the one or more images of one or more ROIs based on the first image of the subject. Further example, the processor 120 may determine one or more second images based on the one or more images of the one or more ROIs and image processing models (e.g., optimization models) corresponding to the one or more ROIs; and a target image is obtained based on the one or more second images.

In some embodiments, the processor 120 may send the target image to a display device for display of the target image.

In some embodiments, the processor 120 may be a single server or a server group. The server group may be centralized or distributed. In some embodiments, the processor 120 may be local or remote. In some embodiments, the processor 120 may be connected to the imaging device 110, the storage device 140, either over a network 130 or directly to access information and/or data stored thereon. In some embodiments, the processor 120 may be integrated in the imaging device 110. In some embodiments, the processor 120 may be implemented on a cloud platform. By way of example only, the cloud platform may include a private cloud, a public cloud, a hybrid cloud, a community cloud, a distributed cloud, an on-premises cloud, a multi-cloud, etc., or any combination thereof.

The network 130 may include any suitable network that may facilitate the exchange of information and/or data for the image processing system. In some embodiments, one or more components of the image processing system (e.g., the imaging device 110, the processor 120, and the storage device 140) may be connected and/or in communication with other components of the image processing system via the network 130. For example, the processor 120 may acquire the first image from the imaging device 110 via the network 130. As another example, the processor 120 may obtain computer instructions from the storage device 140 via the network 130.

In some embodiments, the network 130 may be any one or more of a wired network or a wireless network. For example, the network 130 may include a cable network, a fiber optic network, a telecommunication network, the Internet, a local area network (LAN), a wide area network (WAN), a wireless local area network (WLAN), a metropolitan area network (MAN), a public switched telephone network (PSTN), a Bluetooth network, a ZigBee network (ZigBee), a near-field communication (NFC), an in-device bus, an in-device line, a cable connections, etc. or any combination thereof.

The storage device 140 may store data, instructions, and/or any other information. In some embodiments, the storage device 140 may store data obtained from the imaging device 110 and the processor 120. In some embodiments, the storage device 140 may store data and/or instructions used by the processor 120 to perform or use the exemplary methods described in the present disclosure that have been completed.

In some embodiments, the storage device 140 may be used to store computer instructions or computer programs. For example, software programs as well as modules of an application, such as a computer program corresponding to the image processing method in embodiments of the present disclosure. The processor 120 performs various functional applications as well as data processing by running computer instructions or computer programs stored within the storage device 140, i.e., to implement the image processing method described in the embodiments of the present disclosure. The storage device 140 may comprise a high-speed random memory, and may also comprise a non-volatile memory, for example, one or more magnetic storage devices, a flash memory, or other non-volatile solid-state memory. In some examples, the storage device 140 may further include a memory that is remotely set with respect to the processor 110, and these remote memories may be connected to a terminal over a network. Examples of the aforementioned networks include, but are not limited to, the Internet, an enterprise intranet, a local area network, a mobile communications network, and any combination thereof. In some embodiments, the storage device 140 may be implemented on a cloud platform. In some embodiments, the storage device 140 may be part of the processor 120.

It should be noted that the application scenario 100 of the image processing system arc provided for illustrative purposes only and are not intended to limit the scope of the present disclosure. For a person of ordinary skill in the art, a variety of modifications or variations may be made in accordance with the description of the present disclosure. For example, the application scenario 100 of the image processing system may also include databases, information sources, or the like. As another example, the application scenario 100 of the image processing system may be implemented on other devices to achieve similar or different functionality. Changes and modifications, however, do not depart from the scope of the present disclosure.

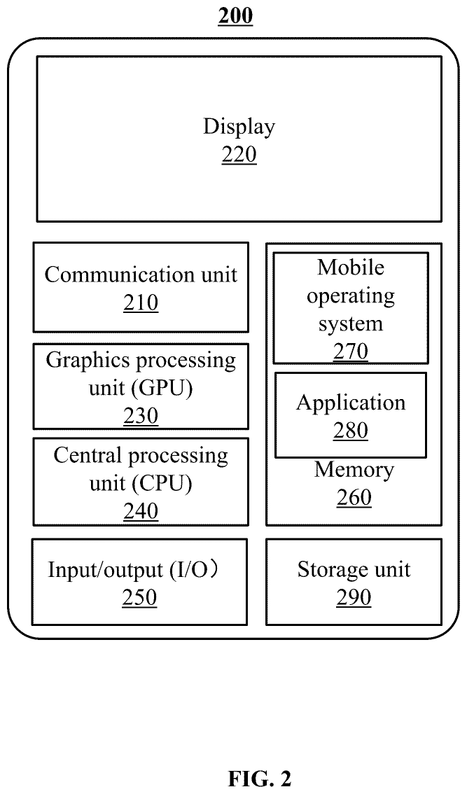

FIG. 2 is a schematic diagram illustrating an exemplary computing device on which a particular system can be implemented according to some embodiments of the present disclosure. In some embodiments, the computing device is configured to process information related to medical image processing, and the computing device may be a mobile device 200. The mobile device may include, but is not limited to, a smartphone, a tablet, a music player, a portable game console, a GPS receiver, a wearable computing device (e.g., eyeglasses, a watch, etc.), or the like. The mobile device 200 may include one or more central processing units (CPUs) 240, one or more graphics processing units (GPUs) 230, a display 220, a memory 260, a communication unit 210, a storage unit 290, and one or more inputs/outputs (I/Os) 250. In addition, the mobile device 200 may include, but is not limited to, any other suitable components of the system bus or controller (not shown in FIG. 2). As shown in FIG. 2, a mobile operating system 270 (e.g., IOS, Android, Windows Phone, etc.) and one or more applications 280 may be loaded from the storage unit 290 into the memory 260 for execution by the CPU 240. The application 280 may include a browser or other mobile application for receiving and processing information input in the mobile device 200.

In order to implement the various modules, units, and their functions described above, a computer hardware platform may be used as a hardware platform for one or more of the elements. Because these hardware elements, operating systems, and programming languages are common, it can be assumed that those of skill in the art are familiar with these techniques, and that they can provide the online-to-offline services required in accordance with the techniques described herein. A computer with a user interface can be used as a personal computer (PC) or other type of workstation or terminal device. A computer with a user interface can be used as a server if properly programmed. It may be assumed that a person of ordinary skill in the art could also be familiar with the structure, programs, or general operation of this type of computer device. As such, no additional explanation is provided with respect to the accompanying description.

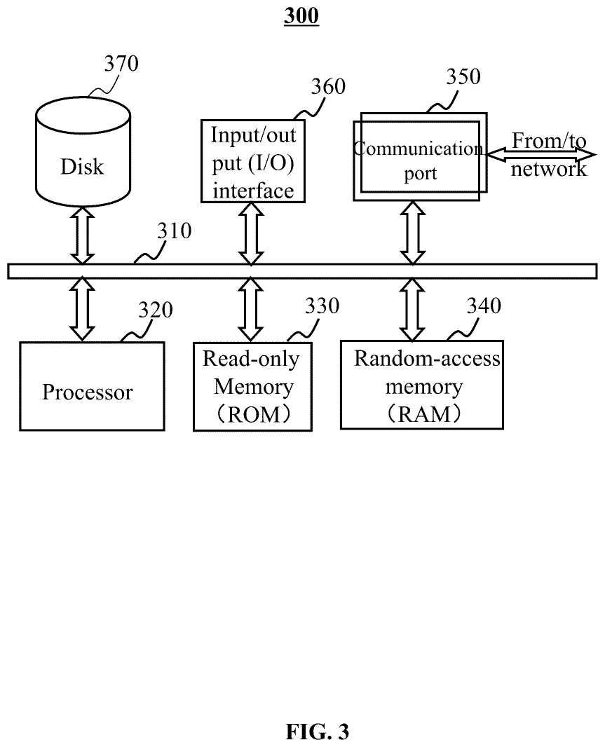

FIG. 3 is a schematic diagram illustrating exemplary hardware and software components of an exemplary computing device according to some embodiments of the present disclosure. A computing device 300 may be configured to perform one or more of the functions of the various modules of the image processing system 100 disclosed in the embodiments of the present disclosure.

The computing device 300 may be a general-purpose computer or a dedicated computer, both of which may be used to implement the image processing system 100 as described herein. The computing device 300 may be used to implement any component of the image processing system 100 as described herein. For example, a processor may be implemented on the computing device 300 by its hardware, software program, firmware, or a combination thereof. For convenience, only one computer is shown in the figures, but the computer functions described herein in connection with medical image processing may be implemented on a plurality of similar platforms in a distributed manner to spread out processing loads.

For example, the computing device 300 may include a communication port 350 that is connected to and/or from a network to enable data communication. The computing device 300 may also include a processor 320 in the form of one or more processors for executing program instructions. Exemplary computer platforms may include an internal communication bus 310, different types of program memory and data memory (e.g., a disk 370, a read-only memory (ROM) 330, or a random-access memory (RAM) 340), and various data files processed and/or transmitted by the computer. Exemplary computing platforms also include program instructions executed by the processor 320 stored in the ROM 330, the RAM 340, and/or other forms of non-transitory storage media. The methods and/or processes of the present disclosure may be implemented as program instructions. The computing device 300 may also include an input/output (I/O) interface 360 that may support input/output between the computer and other components. The computing device 300 may also receive programming and data via network communication.

For illustrative purposes only, only one CPU and/or processor is exemplarily described in computing device 300. However, it should be noted that the computing device 300 in the present disclosure may include multiple CPUs and/or processors, and thus operations and/or methods described in the present disclosure may also be implemented by multiple CPUs and/or processors, either jointly or independently. For example, if in the present disclosure, the CPU and/or processor of the computing device 300 performs an operation A and an operation B, it should be understood that the operation A and the operation B may also be performed jointly or independently by two different CPUs and/or processors in the computing device 300 (e.g., a first processor performs the operation A, a second processor performs the operation B, or the first and second processor jointly perform the operation A and the operation B).

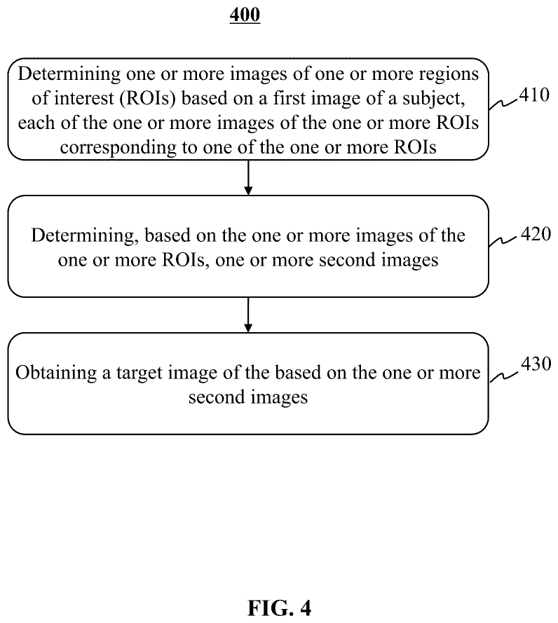

FIG. 4 is a flowchart illustrating an exemplary process of image processing according to some embodiments of the present disclosure. In some embodiments, a process 400 may be performed by an image processing system or a processor (e.g., the processor 120 as shown in FIG. 1). As shown in FIG. 4, the process 400 includes following operations.

In 410, determining one or more images of one or more regions of interest (ROIs) based on a first image of a subject, each of the images of the one or more ROIs corresponding to one of the ROIs.

The subject may include a biological subject (e.g., human bodies, animals, etc.), a non-biological subject (e.g., a body phantom), etc. More descriptions of the subject, please see FIG. 1 and its associated description.

In some embodiments, the first image may include a medical image.

In some embodiments, the first image may include a full-body image of the subject, an abdominal image, an upper-body image, etc. The type of the first image may be related to a type of an imaging device for acquiring the first image. For example, the first image may include a magnetic resonance (MRI) image, a computed tomography (CT) image, an emission computed tomography (ECT) image, a single-photo emission computed tomography (SPECT) image, a positron emission computed tomography (PET) image, an attenuation correction computed tomography (AC-CT) image for a PET/CT system, an attenuation correction magnetic resonance imaging (AC-MR) image for a PET/MR system.

The first image may represent one or more ROIs. The one or more ROIs may correspond to different portions of the subject presented in the first image. For example, an ROI may include a portion of the subject, e.g., an organ (e.g., kidney, liver, heart, etc.), a tissue, a lesion, or the like. In some embodiments, two of the one or more ROIs may include an overlapping region.

In some embodiments, the first image may have an image quality that is lower than a standard image. As described herein, the image quality may be defined by one or more quality parameters. Exemplary quality parameters may include a resolution, a contrast, a noise level, a signal-to-noise ratio, an artifact level, a sampling rate, or the like. The image quality of the first image being lower than the image quality of the standard image refers to a quality parameter of the first image being lower than or greater than a quality parameter of the standard image. For example, the sampling rate of the first image may be lower than the sampling rate of the standard image. As another example, the signal-to-noise ratio of the first image may be lower than the signal-to-noise ratio of the standard image, etc. As still another example, the noise level of the first image may be greater than the noise level of the standard image. In some embodiments, the quality parameter of the standard image may be set by the system by default or by the user according to clinical needs, user preference, etc. For example, the quality parameter of the standard image may also be referred to as a quality parameter threshold, and the quality parameter threshold may be set by the user according to clinical needs, or the like. Furthermore, for example, in a field of medical imaging, medical images of different parts of the body have different clinical needs. For example, for positron emission tomography (PET), a clinical scanning manner may be whole-body scan (plus head scan separately in some cases). The brain image may require that complex structures in a brain can be clearly observed, and the brain image may be required to have a high resolution, whereas an image of a body part requires a high rate of detection of lesions, and thus the clinical needs of the images of the body part may be required to have a high signal-to-noise ratio. Therefore, a user can set a higher resolution threshold for the brain image and a higher signal-to-noise ratio threshold for the body image. The resolution of the first image may be lower than the resolution threshold for the brain and a signal-to-noise ratio of the first image is lower than the signal-to-noise ratio threshold for the body.

In some embodiments, a processor (e.g., the processor 120) may acquire the first image of the subject in real time, e.g., from the imaging device. In some embodiments, the processor may acquire the first image of the subject from a storage device. In some embodiments, the processor may perform an image reconstruction on scanned data (e.g., projection data, MR signals, etc.) of the subject to obtain the first image.

In some embodiments, the processor may reconstruct the scanned data of the subject based on an initial image reconstruction parameter to obtain the first image.

The initial image reconstruction parameter may be defaulting setting of the image processing system 100 or set by a user according to clinical requirements.

The scanned data may be raw data acquired by the imaging device after scanning the subject, e.g., an MR signal acquired by an MRI scan, projection data acquired by a CT scan, raw data acquired by a PET scan. Correspondingly, the first image obtained by reconstructing the scanned data utilizing the initial image reconstruction parameter may be an MRI, a CT image, or a PET image, respectively. For example, when the scanned data is the projection data acquired by the CT scan, the processor may reconstruct the CT scan data using an inverse projection algorithm, an iterative reconstruction algorithm, an analytical algorithm, or the like, to obtain the CT image. As another example, when the scanned data is the MR signal acquired by the MRI scanning, the processor may reconstruct the MRI scan data using a partial Fourier reconstruction algorithm, a sensitivity encoding (SENSE) reconstruction algorithm, a compression-aware reconstruction algorithm, and a deep-learning based MRI reconstruction algorithm etc., to obtain the MRI image.

In some embodiments, a data format of the scanned data may be a chordal graph, a list data schema, or the like.

In some embodiments, the processor (e.g., the processor 120) may also perform a down-sampling operation on the scanned data to obtain target scanned data and reconstruct the first image based on the target scanned data.

In some embodiments, a total amount of data of the target scanned data may be less than a total amount of data of the scanned data. In some embodiments, the processor may reduce the total amount of data of the scanned data by the down-sampling operation to obtain the target scanned data. For example, the processor may represent PET scanned data as a list and discard a portion of the PET scanned data by a certain percentage to obtain the target scanned data. As another example, the processor may reduce CT scanned data by a number of projections, etc., to obtain the target scanned data. In some embodiments, the processor may further reconstruct the target scanned data to obtain the first image in a manner similar to the reconstruction of the scanned data.

In embodiments of the present disclosure, by reconstructing the scanned data of the subject based on the initial image parameter to obtain the first image, or performing the down-sampling operation on the scanned data to obtain the target scanned data, and reconstructing the target scanned data to obtain the first image, first images of different image quality can be obtained quickly based on the scanned data, which improves a speed of image processing.

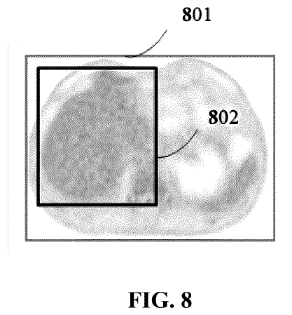

In some embodiments, the image of the ROI may include an organ and/or its surrounding region, a tissue and/or its surrounding region, a lesion and/or its surrounding region, etc. In some embodiments, the image of an ROI may be an image of a region of the first image in which the ROI is located included. One or more ROIs may be included in the first image. The images of the ROIs may include images corresponding to each of the one or more ROIs included in the first image. The first image may include one or more images of the ROIs. As shown in FIG. 8, 801 is the first image in a cross-sectional view, and 802 is an image of a liver recognized in the cross-sectional view.

In some embodiments, different images of ROIs in the one or more images of ROIs correspond to different regions in the first image, and the different regions partially overlap or the different regions do not overlap.

In some embodiments, the processor may determine, based on the first image of the subject, the images of one or moreROIs corresponding to the one or more ROIs in the first image, respectively. Each ROI may correspond to an image of the ROI.

In some embodiments, the processor may segment the first image to determine the one or more images of one or more of ROIs. For example, the processor may identify the one or more ROIs from the first image and mark the identified ROIs (e.g., using a boundary box in 2D or 3D to mark each identified ROI). For each identified ROI, a region in the first image that is marked as the identified ROI may be obtained (e.g., cut) to generate the image of the ROI. The processor may divide the first image by a segmentation algorithm to determine the one or more ROIs. A segmentation manner may include an automatic segmentation algorithm and an interactive editing segmentation algorithm. The automatic segmentation algorithm includes a threshold-based segmentation algorithm, a machine learning-based segmentation algorithm, or the like. The interactive editing segmentation approach may include a region growing segmentation algorithm, a diffuse water filling segmentation algorithm, a slice interpolation segmentation algorithm, an interactive drawing segmentation algorithm, or the like. For example, in a CT/MR image, a tissue organ has unique grayscale characteristics and boundaries are often clear and easily distinguishable. Therefore, segmentation may be performed directly by a segmentation algorithm.

In 420, determining, based on the one or more images of the one or more ROIs, one or more second images. Each of the one or more second images may correspond to one of the one or more images of the one or more ROIs and represent an ROI in the one of the images of the one or more ROIs. Each of the one or more second images may be determined based on one or more trained machine learning models for image processing (also referred to as image processing models) corresponding to the one of the images of the one or more ROIs, wherein the image quality of the second image is higher than the image quality of the image of the ROI. A trained machine learning model for image processing corresponding to an ROI (also referred to as a first trained machine learning model or an image processing model, e.g., an image processing model).

The image processing models corresponding to an image of an ROI may also correspond to the ROI represented in the image. The corresponding image processing model may be used to process the image of the ROI corresponding to the corresponding image processing model. For example, if the one or more ROIs includes a first ROI and a second ROI, the first ROI may correspond to one or more image processing models 1, 2, . . . , n, and the second ROI may correspond to one or more image processing models 1, 2, . . . , m. The value of m may be the same as or different from the value of n. The one or more image processing models 1, 2, . . . , n corresponding to the first ROI may be used to process an image of the first ROI and the one or more image processing models 1, 2, . . . , m corresponding to the second ROI may be used to process an image of the second ROI.

In some embodiments, different images of ROIs in the one or more images of the one or more ROIs are processed by different trained machine learning models, the different trained machine learning models corresponding to different optimization directions.

An image processing model may be used to perform an image processing operation (e.g., an optimization operation such as a noise reduction operation, an enhancement operation, a segmentation operation, a de-artificing operation, a resolution improvement operation, etc.) on the image of an ROI to improve or decrease a quality parameter of the image of the ROI. For example, an image processing model may include a noise reduction model, and the noise reduction model may be used to perform noise reduction on the image of the ROI to reduce a noise level or increase a signal-to-noise ratio of the image of the ROI. As another example, an image processing model may include an enhancement model, and the enhancement model may be used to optimize and enhance the image of the ROI. As still another example, the image processing model may include a super-resolution model, and the super-resolution model may be used to increase the resolution of the image of the ROI. As still another example, the image processing model may include a segmentation model, and the segmentation model may be used to segment the image of the ROI.

In some embodiments, at least one of the one or more image processing models corresponding to each ROI may be in the same type. In other words, the image processing models of the same type corresponding to the one or more ROI may perform a same type of image processing operation on the one or moreimages of the one or more ROI. As described herein, a type of an image processing model may be defined by a type of image processing operation (e.g., an optimization operation) performed by the image processing model. For example, the type of the image processing model (e.g. an image processing model) may be a noise reduction model for performing a noise reduction operation. As a further example, the first ROI may correspond to an image processing model for performing a first image processing operation on the image of the first ROI and the second ROI may correspond to an image processing model for performing a second image processing operation on the image of the second ROI. The first image processing operation may be the same as the second image processing operation, and the type of the image processing model corresponding to the first ROI may be the same as the type of the image processing model corresponding to the second ROI.

In some embodiments, the image processing models of a same type corresponding to the one or more ROIs may include, for example, an image processing model 1, an image processing model 2, . . . , an image processing model N, corresponding to the one or more ROIs, respectively. For example, the image processing model 1 may be configured to process an image of a ROI 1, the image processing model 2 may be configured to process an image of a ROI 2, . . . , and the image processing model N is configured to process an image of an ROI N. In some embodiments, the image processing model of the same type corresponding to the one or more ROIs and used to perform the same imaging processing operation (e.g., the same image processing operation) may correspond to different imaging processing effects (e.g., optimization effects). As described herein, an imaging processing (e.g., optimization) effect of the image processing model may be defined by a difference degree between a quality parameter of an image (e.g., an image of an ROI) before processing by the image processing model and a quality parameter of the image after processing (e.g., a second image of the ROI). For example, the image processing effect may be defined by a degree of image processing of a level of noise reduction or a level of super-resolution.

In some embodiments, the image processing models of the same type corresponding to the one or more ROIs may include the same one image processing model. In other words, the same one image processing model may be used to perform the same image processing operation on the one or more images of the ROI.

In some embodiments, at least one of the one or more image processing models corresponding to each ROI may be in different types. For example, the first ROI may correspond to an image processing model for performing a first image processing operation on the image of the first ROI and the second ROI may correspond to an image processing model for performing a second image processing operation on the image of the second ROI. The first image processing operation may be different from the second image processing operation, and the type of the image processing model corresponding to the first ROI may be different from the type of the image processing model corresponding to the second ROI. As a further example, the first ROI may correspond to the image processing model for performing a noise reduction operation on the image of the first ROI and the second ROI may correspond to the image processing model for performing an artifact reduction operation on the image of the second ROI.

In some embodiments, the one or more image processing models corresponding to the same ROI may be in different types. For example, the image processing models of different types corresponding to an ROI may perform different image processing operations on the image of the ROI. For example, the one or more image processing models corresponding to the same ROI image processing model may include a noise reduction model and a super-resolution model, and the ROI may represent a liver of the human body. An intermediate second image of the liver may be obtained by inputting the image of the liver into the noise reduction model corresponding to the image of the liver, an image processing model and another intermediate second image of the liver with an improved resolution may be obtained by inputting the image of the liver into the super-resolution model corresponding to the image of the liver. The two intermediate second images may be fused to determine the second image of the liver.

In some embodiments, the image processing model may include at least one of a Convolutional Neural Networks (CNN) model, a U-Net model, a V-Net model, or a U-Net++ model. In some embodiments, the image processing model may be other models, e.g., a model based on a particular algorithm.

In some embodiments, the processor may generate a second image representing an ROI by inputting the image of the ROI into each of the one or more image processing models corresponding to the ROI. In some embodiments, the count of the one or more image processing models corresponding to the ROI may equal to 1, the output of the single one image processing model may be designated as the second image. In some embodiments, the count of the one or more image processing models corresponding to the ROI may be greater than 1, the output of each of the multiple image processing models may be designated as an intermediate second image. The second image of the ROI may be determined by fusing the multiple intermediate second images outputted by the multiple image processing models by processing the image of the ROI. The image quality of the second image may be higher than the image quality of the image of the ROI.

In some embodiments, the processor may obtain an image processing model by real-time training or pre-training. The real-time training refers to a process of training a model based on relevant data of a current subject after obtaining the relevant data of the current subject. The relevant data of the current subject may include scanned data of the current subject, the first image, or the like, or a combination thereof. The pre-training refers to a process of training a model based on a large amount of relevant data of a large number of historical subjects. The relevant data of the historical subject may include historical scanned data of the historical subject, a historical first image, a historical second image, or the like, or a combination thereof. In actual application, a pre-trained image processing model may be directly called.

In some embodiments, the processor may train a preliminary image processing model to obtain the image processing model. In some embodiments, the processor may determine a first training dataset based on a plurality of pairs of sample images, each pair of the plurality of pairs of sample images including a sample first image and a sample second image of a sample subject, wherein the image quality of the sample second image is higher than the image quality of the sample first image. The first training dataset may include first training samples and first training labels; and the image processing model may be obtained by training the preliminary image processing model based on the first training dataset.

In some embodiments, the sample subject may be a historical scanned subject, and the sample first image and the sample second image may be determined based on historical scanned data of the historical subject.

In some embodiments, the processor may determine the first training dataset (i.e., historical training dataset) based on the historical scanned data of the sample subject (i.e., the historical subject). In some embodiments, the historical scanned data may include scanned data obtained by scanning the sample subject (i.e., the historical subject).

In some embodiments, the processor may reconstruct the scanned data based on the scanned data to obtain a high-quality image and perform image segmentation on the high-quality image to obtain the sample second image of each ROI in the high-quality image as the first training label. The processor may further perform postprocessing operation (e.g., down-sampling process, noise addition process, artifact addition process, resolution reduction process, etc.) on the high-quality image to obtain a low-quality image, perform the image segmentation on the low-quality image to obtain a sample image of the each ROI, and designate the sample image of the each ROI as the sample first image. In some embodiments, the processor may mark each ROI in the high-quality image using a boundary box and cut the high-quality image based on the boundary box to obtain the sample second image of each ROI. The processor may match or map boundary boxes marking the one or more ROIs in the high-quality image to the low-quality image to segment the low-quality image to obtain the sample first image.

In some embodiments, the processor may reconstruct the low-quality image based on the scanned data and perform image segmentation on the low-quality image to obtain the sample image of the each ROI in the low-quality image, and designate the sample image of the each ROI in the low-quality image as the sample first image. The processor may further optimize the low-quality image to obtain the high-quality image and perform image segmentation on the high-quality image to obtain the sample second image of the each ROI. In some embodiments, the processor may mark each ROI in the low-quality image using a boundary box and cut the low-quality image based on the boundary box to obtain the sample first image of each ROI. The processor may match or map boundary boxes marking the one or more ROIs in the low-quality image to the high-quality image to segment the high-quality image and obtain the simple second image.

In some embodiments, a first training sample in the first training dataset may be the sample first image, and the first training label may be one or more sample second images corresponding to the sample first image. It should be noted that the image processing model obtained by training based on the sample first image and corresponding one or more sample second images may optimize images of one or more ROIs.

In some embodiments, the first training sample in the first training dataset may also include the sample image of the ROI. The sample image of the ROI may be obtained by performing image segmentation on the sample first image. The first training label may be the sample second image corresponding to the sample image of the ROI. It should be noted that the sample image of the ROI of a ROI of one type and its corresponding sample second image may form a training dataset, which is used to train an image processing model corresponding to the ROI of the type. In this embodiment, a single training dataset may comprise a large number of sample images of ROIs corresponding to a ROI of one type and their corresponding first training labels. A type of the sample image of the ROI in each training dataset is the same as a type of an image of a ROI that can be processed by this image processing model. The image processing model obtained by training with the single training dataset may be targeted to optimize and process an image a ROI of one type.

In some embodiments, the processor may pre-train to obtain the image processing model based on the first training dataset. In some embodiments, the processor may obtain the image processing model by instantly training the preliminary image processing model based on the first training dataset in response to receiving an instruction to perform an image processing operation on the image of the ROI. A training process is the same for instant training and pre-training, with a difference being a timing of the training. In some embodiments, the processor may be trained by various algorithms based on the first training sample with the first training label. For example, the training may be performed based on a gradient descent algorithm. An exemplary training process may include inputting each of a plurality of first training samples with the first training label into the preliminary image processing model, constructing a loss function by a result of the preliminary image processing model and the first training labels, iteratively updating parameters of the preliminary image processing model based on the loss function. When a termination condition is satisfied, the training of the preliminary image processing model may be terminated and a trained image processing model may be obtained. The termination condition may be that the loss function converges, a count of iterations reaches a threshold, etc.

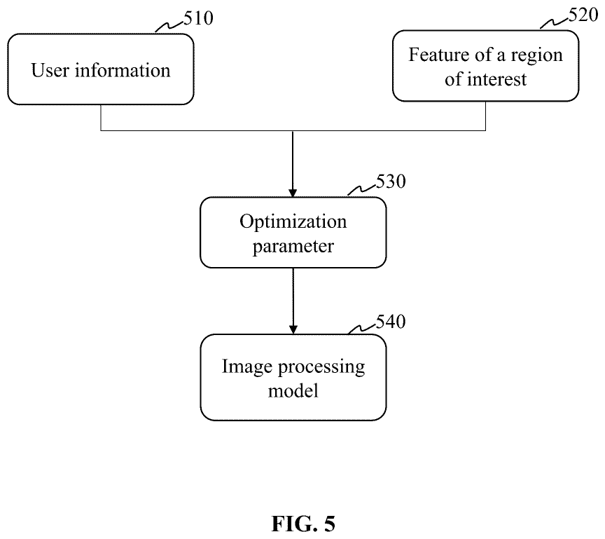

In some embodiments, the first training dataset may be associated with an optimization parameter. In some embodiments, the first training sample may further include a sample optimization parameter. Please see FIG. 5 and its related descriptions for more content on the optimization parameter.

In the embodiment of the present disclosure, the preliminary image processing model is directly trained by the first training sample and the first training label, which can utilize the self-learning capability of the machine learning model to find a law from a large amount of historical data and obtain a relationship between the first image and the second image, henceforth improving the quality of image processing.

In some embodiments, the image processing models corresponding to ROIs of different types may be pre-trained and stored in a storage device. An image processing model that is pre-trained and stored in the storage device and is used to process an image corresponding to a ROI of one type may be referred to as a candidate model.

In some embodiments, the image processing model corresponding to an ROI represented in the first image may be determined from a plurality of candidate models. In some embodiments, the processor may select and determine an image processing model corresponding to the ROI represented in the first image among the plurality of candidate models stored in the storage device based on a type of the ROI. For example, each of the plurality of candidate models may correspond to a type of ROI. The processor may determine one of the pluralities of candidate models corresponding to a type of ROI the same as the type of the ROI represented in the first image as the image processing model corresponding to the ROI represented in the first image.

In some embodiments, for an image of an ROI or an ROI represented in the first image, one or more candidate models may be determined from the plurality of candidate models, and the one or more candidate models may be used as the image processing models corresponding to the ROI. For example, when one optimization direction is desired, one candidate model corresponding to the optimization direction may be determined from the plurality of candidate models. When a plurality of optimization directions is needed, a candidate model corresponding to each of the plurality of optimization directions may be determined from the plurality of candidate models. For more description on the optimization direction, please refer to other parts of FIG. 4, FIG. 5 and related descriptions thereof.

In some embodiments, the plurality of candidate models may include a noise reduction model (whose optimization direction is noise reduction), an enhancement model (whose optimization direction is signal-to-noise ratio enhancement), a super-resolution model (whose optimization direction is resolution increase), or the like.

In some embodiments, a candidate model may include at least one of a U-Net model, a V-Net model, or a U-Net++ model.

In some embodiments, an input to the candidate model may be the first image and an output of the candidate model may be a third image. The third image may be an intermediate second image in determining the second image. The third image may be an image of an organ image after the organ image is optimized by the candidate model along a certain optimization direction.

In some embodiments, the processor may obtain the candidate model by training a preliminary candidate model.

In some embodiments, the processor may determine second training dataset based on the sample first image and a sample third image of the sample subject. The second training dataset may include second training samples and second training labels. The processor may train the preliminary candidate model based on the second training dataset to determine the candidate model.

In some embodiments, the sample subject may be a historical subject and the sample first image and the sample third image may be determined based on historical scanned data of the historical subject. In this embodiment, the second training dataset is historical training dataset.

In some embodiments, the processor may determine the second training dataset (the historical training dataset) based on the historical scanned data of the sample subject. The second training sample in the second training dataset (the historical training dataset) may be determined in a similar manner to the first training sample in the first training dataset and will not be repeated here. In some embodiments, the second training label may be determined based on the optimization parameter. For example, the processor may obtain the sample third image by reconstruct scanned data obtained from historical scan under a corresponding optimization direction and designate the sample third image as the second training label.

In some embodiments, the processor may pre-train to obtain the candidate model based on the second training dataset. In some embodiments, the processor may, in response to receiving an instruction to perform an image processing operation along a certain optimization direction on an image of a ROI, instantly train to obtain the candidate model based on corresponding second training dataset. Training process of instant training and pre-training is the same, with a difference being the timing of the training. In some embodiments, the processor may perform training in various methods based on the second training sample with the second training label. For example, the training may be performed based on a gradient descent approach. A training process of the candidate model is similar to a training process of the image processing model, more related descriptions may be referred to the preceding related descriptions.

In some embodiments, the second training dataset may be associated with the optimization parameter. For example, the second training label may be determined based on the optimization parameter, and the processor may reconstruct the scanned data based on the optimization parameter to obtain the third sample image under the corresponding optimization direction and use the third sample image as the second training label. In some embodiments, the second training sample may further include a sample optimization parameter.

In some embodiments, the second training sample in the historical training dataset may be the sample first image, and the second training label may be the sample third image obtained by optimizing one of the sample second images corresponding to the sample first image.

In some embodiments, the second training sample in the historical training dataset may be a sample image of an ROI. The sample image of the ROI may be obtainable by performing image segmentation on the sample first image. The second training label may be a sample third image corresponding to the sample image of the ROI.

In some embodiments, there may be a plurality of candidate models trained for the same optimization direction. The plurality of candidate models with the same optimization direction may have different image processing effects for a same image of an ROI. For example a plurality of candidate models for resolution enhancement may have different degrees of clarity enhancement for the same image of an ROI.

In some embodiments, there may be a plurality of candidate models having the same optimization direction and corresponding to different types of ROIs.

In some embodiments, the processor may determine a count of candidate models corresponding to ROIs of different types based on a complexity and historical lesion rate of the ROIs of different types.

For example, if an ROI (e.g., an organ) is of higher complexity (e.g., a brain), more detailed screening is required, so a count of candidate models may be as high as possible, and in particular, more candidate models with enhanced image resolution may be trained to enhance a clarity of a finally-determined target image. For an ROI with a high historical lesion rate (e.g., the organ), to be able to increase a lesion detection rate, more candidate models for boosting image texture may be trained to choose from, i.e., a count of candidate models for boosting image texture may be higher. The historical lesion rate may be a percentage of cases in historical data in which an ROI (e.g., the organ) has lesions.

It should be noted that even though they are all designed to enhance one of the image parameters, image processing effects of the candidate models on images of different ROIs may be different due to differences in a type of architecture of the candidate models and optimization parameters used to construct the training data. Therefore, it is necessary to train a plurality of candidate models for selecting a more suitable image processing model.

In embodiments of the present disclosure, by determining candidate models and then determining the one or more image processing models from the candidate models, a variety of candidate models corresponding to different ROIs may be pre-trained and the most suitable candidate model may be selected as the one or more image processing models to improve the quality of image processing.

In some embodiments, for each image of the ROI, the processor may determine an image processing model corresponding to t one of the one or more images of the one or more ROIs based on at least one of user information or a feature of the ROI. The feature of the ROI may be determined based on the one of the one or more images of the one or more ROIs.

The user information may be information related to a user. The user information may be obtained from outside the image. In some embodiments, the user information may include at least one of a user's primary treatment direction, the user's requirement for the image, or the like, or a combination thereof. The user may be a doctor of the subject, a nurse, or the like.

In some embodiments, the user's requirement for the image of an ROI may include requirements such as the user's reading preference for e images in terms of noise texture, image contrast, image resolution, or the like. The image processing model may be determined based on the user's requirement for the image, and the image of an ROI may be optimized according to the user's preference by the image processing model. The user's primary treatment direction may be a direction of a relevant disease that the user (e.g., a physician) has expertise in and is responsible for treatment. The image processing model may be determined according to the user's primary treatment direction, and the image processing model may be used to optimize the image according to the user's primary treatment direction, so that it is easy for the user to read the image of the ROI to make a diagnosis. When the user information includes only the user's primary treatment direction, a necessary image reading requirement may be satisfied based on the user's primary treatment direction as much as possible without the user specifying an image requirement.

In some embodiments, the processor may obtain the user information based on a user input, e.g., at least one of the user's primary treatment direction, the user's request for an image, etc., which may be obtained based on the user input. In some embodiments, the processor may automatically determine the user information based on stored primary treatment direction of the user (e.g., stored in the storage device).

In some embodiments, the user information may include a target image parameter. The target image parameter is an optimized parameter that the user expects to obtain. In some embodiments, the target image parameter may include at least one of a target signal-to-noise ratio, a target resolution, a target contrast, or a target image texture.

In some embodiments, the processor may perform statistics on the user treatment record to determine a user treatment feature; based on the user treatment feature, obtain an image reading record corresponding to the user treatment feature by matching a user database; based on the image reading record, perform statistics to determine a preferred image parameter (i.e., the target image parameter).

The user treatment record may include a data record of cases that the user has treated. In some embodiments, the user treatment record may include a type of disease, a site of the disease (what organ or tissue it is located in), etc., of cases that the user has treated.

The user treatment feature may include a feature associated with cases that the user has treated. In some embodiments, the user treatment feature may include a distribution feature of different types of diseases treated by the user, and a distribution feature of different parts of the diseases.

The image reading record may include a history related to when the user reads an image. In some embodiments, the image reading record may include a parameter of an image read by the user (e.g., a resolution, a signal-to-noise ratio, etc.), a record of adjustments made by the user to manually adjust the parameter of the image (e.g., a record of adjustments made to the signal-to-noise ratio, the resolution, a contrast, an image texture, etc.).

In some embodiments, the processor may, based on the user's treatment feature, perform a match in the user database to obtain the image reading record corresponding to the user's treatment feature. A large count of image reading records of the user may be stored in the user database in a manner that the user treatment feature corresponds one-to-one to the image reading record. The processor may retrieve an image reading record corresponding to the same or similar user treatment feature in the user database based on the user treatment feature, thereby obtaining the image reading record corresponding to the user treatment feature. In some embodiments, the processor may supplement the user database with an image reading record related to each time the user reads the image or manually adjusts the parameter of the image, etc.

In some embodiments, the processor may count image parameters and data on an adjustment made to the image by the user (e.g., enhancing the signal-to-noise ratio, enhancing the contrast ratio, etc.) each time the image is read in the image reading record corresponding to the user's treatment feature. The processor may use a statistical value of adjusted image parameters in a plurality of image reading records as the preferred image parameter. The statistical value may include at least one of a mean, a plurality, a median, or the like.

In embodiments of the present disclosure, adding the preferred image parameter to the user information for a subsequent determination of the image processing model can make the image processing model optimize the organ image to be more in line with image reading needs of different types of users, and improve the user experience.

In some embodiments, the user information may include lesion information. The processor may determine the lesion information based on diagnostic information and the first image through a lesion model.

The lesion information may be data related to a lesion of the subject. The lesion information may include a type, a location, a size, etc., of a lesion in the image (e.g., the first image, etc.). The location, size, etc., of the lesion in the image may be represented by coordinates of a lesion boundary.

The diagnostic information may be the user's initial diagnostic of the subject. The diagnostic information may include the subject's symptoms, an initial suspected cause of a disease, and other underlying physiologic data (e.g., gender, age, blood pressure, heart rate, history of medical conditions, etc.).

In some embodiments, the lesion model may be a trained machine learning model (also referred to as a second trained machine learning model for image processing), e.g., a CNN, etc. In some embodiments, an input to the lesion model may include the diagnostic information and the first image, and an output of the lesion model may include the lesion information.

In some embodiments, the lesion model may be obtained by training a preliminary machine learning model (also referred to as a preliminary second trained machine learning model or a preliminary lesion model) using a plurality of lesion training samples each of which has a lesion training label. In some embodiments, a lesion training sample may include sample diagnostic information and a sample first image, and the lesion training label may be actual lesion information in the sample first image. The lesion training sample may be obtained based on a diagnostic record of a historical patient, the sample diagnostic information may be historical diagnostic information of the historical patient, and the sample first image may be a first image of the historical patient. The lesion training label may be the actual lesion information of the historical patient obtained by manually performing labeling based on information of the historical patient. The preliminary machine learning model may be a CNN model.

In some embodiments, the processor may perform training in various algorithms based on the lesion training sample with the lesion training label. For example, the training may be performed based on a gradient descent algorithm. An exemplary training process may include inputting each of a plurality of lesion training samples with a lesion training label into the preliminary lesion model, constructing a loss function from a result of the preliminary lesion model and the lesion training label, based on the loss function, iteratively updating parameters of the preliminary lesion model. When a termination condition is satisfied, the training of the preliminary lesion model may be terminated and the lesion model may be obtained. The termination condition may be that the loss function converges, a count of iterations reaches a threshold, etc.

In an embodiment of the present disclosure, adding the lesion information to the user information can be combined with the location of the lesion to select image processing models corresponding to images of different organs, so that an image obtained by the image processing model is more convenient for a doctor to diagnose the patient's condition.

The feature of the ROI may be feature information associated with the image of the ROI. In some embodiments, the feature of the ROI may include a type of the ROI (e.g., an organ, a tissue, a lesion, etc.), a parameter of an image (e.g., a resolution, a signal-to-noise ratio, an image texture, etc.), or the like.

In some embodiments, the processor may identify a contour in the image of the ROI based on a change in a contrast gradient in the image of the ROI. The processor may further identify the type of the ROI by searching in a database based on the contour. The database may include at least one of an organ database, a tissue database, a disease database, or the like. Organ contour images of a plurality of organs may be pre-stored in the organ database. Tissue contour images of a plurality of tissues may be pre-stored in the tissue database. Lesion contour images of a plurality of lesions may be pre-stored in the lesion database. For example, the processor may retrieve an organ contour image similar to the contour in the organ database and determine an organ type of the organ contour image based on organ information belonging to the stored organ contour image, and determine the organ type as the type of the ROI.

In some embodiments, the processor may also read image data of the image of the ROI to obtain image parameters such as a resolution, an image texture, a signal-to-noise ratio, or the like.

In some embodiments, the feature of the ROI may further include surrounding tissue information of the ROI. The surrounding tissue information may be information related to tissues within a certain range (e.g., within a preset range) around the ROI. The surrounding tissue information may include at least one of a type of surrounding tissues, a tissue distribution density, or tissue overlap information.

The type of surrounding tissues may include blood vessels, bone, fat, or other vital tissues, etc.

The tissue distribution density may include a distribution density of blood vessels of different thicknesses, a distribution density of fat, etc. The tissue distribution density may be expressed in terms of a percentage of area/volume of different tissues within a certain range of a periphery of an organ, a tissue, or a lesion in the image of the ROI, or the like.

The tissue overlap information may be overlapping situation of surrounding tissues. The tissue overlap information may include an overlapping situation of vessels themselves (e.g., between different vessels), an overlapping situation of vessels with bone, etc. The tissue overlap information may be expressed in terms of a type of tissues that overlap within a certain range around the periphery of the organ, tissue, or lesion in the image of the ROI, as well as an overlapping area/volume.

In some embodiments, the processor may determine tissue information in each direction within a certain range around the image of the ROI by locating and querying in a three-dimensional tissue model based on the image of the ROI.

The three-dimensional tissue model may be a three-dimensional human body modeling image that contains various tissue images. The three-dimensional tissue model may be obtained based on a variety of medical images in advance. In some embodiments, the three-dimensional tissue model may be constructed according to gender, age stage, or the like. When performing a query, the processor may query in the three-dimensional tissue model corresponding to gender, age stage, or the like.

In some embodiments, the processor may locate the ROI in the three-dimensional tissue model based on the type of the ROI in the image of the ROI, and then obtain, from the three-dimensional tissue model, tissue information in all directions within a certain range around the ROI. For example, if an ROI in an image of a ROI is a liver, the processor may target the liver in the three-dimensional tissue model, and then further obtain tissue information in each direction within a certain range around the liver.

In an embodiment of the present disclosure, adding the surrounding tissue information to the feature of the ROI enables an image processing model determined based on the feature of the ROI to present surrounding important tissue information as clearly as possible when optimizing an image, henceforth avoiding loss of important information.

In some embodiments, the processor may determine the image processing model corresponding to the image of the ROI based on at least one of the user information or the feature of the ROI in multiple ways. For example, based on the a priori knowledge, main optimization directions of different types of image processing models may be determined. For example, an image processing model may be configured to perform a resolution optimization, or perform an image texture optimization. The processor may determine, based on the user information and/or the feature of the ROI, an image parameter of the image of the ROI that needs to be optimized, so as to select an image processing model corresponding to the optimization direction.

In some embodiments, the processor may determine an optimization parameter for the image processing model based on at least one of the user information or the feature of the ROI, thereby determining an image processing model corresponding to the image of the ROI. More information about the optimization parameter and determining the image processing model can be found in FIG. 5 and its related descriptions, which will not be repeated here.

In some embodiments, the processor may also determine the image processing model corresponding to the image of the ROI by selecting from the plurality of candidate models based on at least one of the user information or the feature of the ROI. For example, the processor may determine, based on the feature of the ROI, a plurality of candidate models for processing the image of the ROI of a corresponding type; and, based on the user information, determine a candidate model for optimizing a corresponding image parameter from the plurality of candidate models corresponding to the ROI of a corresponding type. The image parameter may be determined based on the target image parameter in the user information. For example, when the target image parameter is a target resolution, the image parameter to be optimized is a resolution.

In embodiments of the present disclosure, determining image processing models corresponding to different images of ROIs based on the user information or the feature of the ROI can make the image processing model optimize the image of the ROI in a more targeted manner and achieve the global optimum.

In some embodiments, the processor may determine one or more second images based on one or more images of the one or more ROIs and image processing models. For the plurality of images of the ROI, the processor may determine a second image corresponding to each image of the ROI based on a single image processing model.

In some embodiments, there is a plurality of image processing models corresponding to each image of the ROI; and the processor may determine the second image based on each image of the ROI and the image processing models corresponding to the image of the ROI. For the one or more images of the one or more ROIs, the processor may determine one or more second images based on a plurality of corresponding image processing models, respectively.

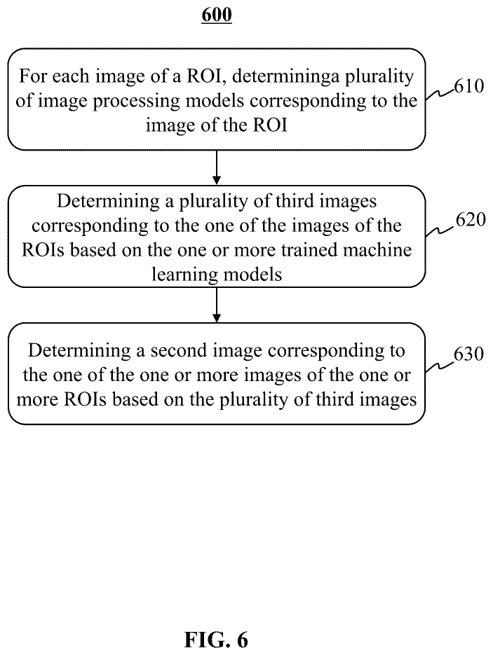

In some embodiments, each image of the ROI corresponds to a plurality of image processing models; the processor may determine a plurality of image processing models corresponding to each image of the ROI, and based on the plurality of image processing models, determine a plurality of third images (i.e., intermediate second images) corresponding to one image of the ROI; and based on the plurality of third images corresponding to one image of the ROI, determine the second image corresponding to the image of the ROI. More information about this embodiment may be referred to FIG. 6 and its related description, which will not be repeated here.

In 430, obtaining a target image of the subject based on the one or more second images.

The target image may be an optimized medical image of the first image of the subject.

In some embodiments, one ROI represented in the first image may be included in the target image. In some embodiments, the target image may be a complete optimized image obtained by fusing the one or more second images. In some embodiments, the one or more ROIs represented in the first image may be included in the target image. In some embodiments, the target image may be a complete optimized image obtained by fusing the one or more second images. In some embodiments, the target image may be a complete optimized image obtained by fusing the one or more second images and the first image. Image fusion may be done by fusing a better image on top of a base image to improve the image quality.

In some embodiments, the processor may directly fuse the one or more second images and the first image to obtain the target image. In some embodiments, the processor may use an image fusion algorithm to perform the fusion operation on the one or more second images and the first image to obtain the target image. In some embodiments, the one or more second images and the first image may also be fused to obtain the target image in any manner known to those skilled in the art, and the present disclosure does not limit this.

In some embodiments, the processor may perform the fusion operation on the one or more second images based on a fusion coefficient to determine the target image. In some embodiments, the processor may perform a weighted fusion on the plurality of second images and the first image based on the fusion coefficients corresponding to the one or more second images and/or the first image to determine the target image.

A fusion coefficient corresponding to plurality of images may be a weighted coefficient for a weighted fusion of the one or more second images and the first image. The fusion coefficient may be determined empirically. The fusion coefficient may affect a continuity of an image at boundaries.

The fusion coefficient may be expressed as a value. For illustrative purposes only, the second image may be denoted as Rᵢ, where i=1, 2, . . . , N, I denotes a serial number of the second image, and a fusion coefficient of the second image may be denoted as Wᵢ, i=1, 2, . . . , N. For each second image, the processor may multiply the second image with a corresponding fusion coefficient; then a result of the multiplication is summed with the first image to obtain the target image.

In some embodiments, the fusion coefficient corresponding to a second image may be determined based on lesion information in the second image. The higher the size of a lesion in the second image as a percentage of the second image, and the closer the location of the lesion is to a boundary splicing location of the second image, the larger the fusion coefficient of the second image may be to ensure that the lesion information can be more clearly presented to the user.

During an image fusion process, if there is a large difference in quality between different images, it may produce a more abrupt change in vision. In embodiments of the present disclosure, a manner of fusing the plurality of second images based on the fusion coefficient reduces abrupt changes in the vision and improves the visual experience.

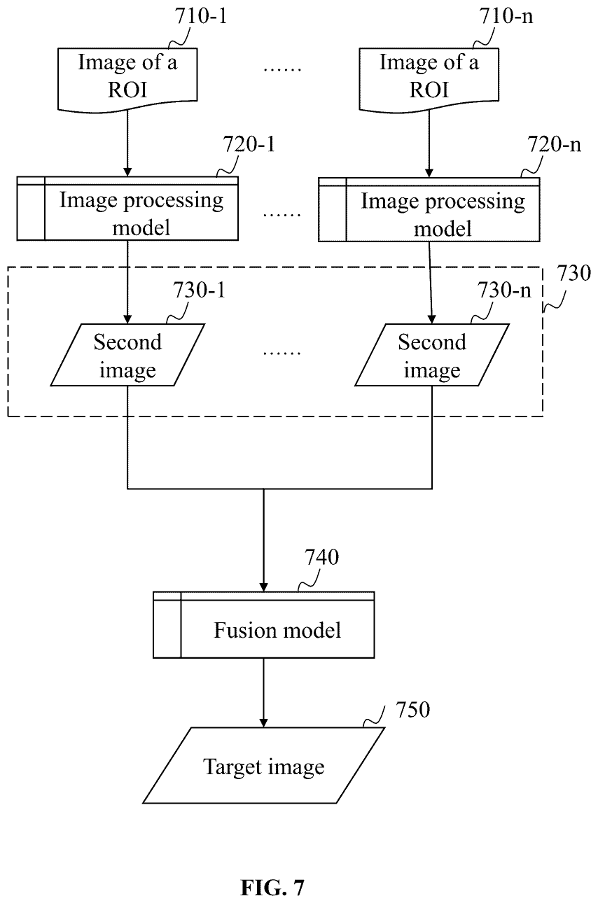

In some embodiments, the processor may also determine the target image based on the second image by performing the fusion operation through a fusion model (also referred to as a third trained machine learning model for image processing). More descriptions for the fusion operation via the fusion model can be found in FIG. 7 and its related description.

In some embodiments, the processor may directly optimize the first image to obtain a fifth image. In some embodiments, the processor may determine a sixth image based on the first image. The sixth image being determined based on an overall processing model, wherein the overall processing model is a machine learning model. In some embodiments, the processor may obtain the target image of the subject by performing the fusion operation on the one or more second images and the sixth image.

The sixth image may be obtained after directly optimizing the first image. The sixth image may have better image quality compared to the first image.

The overall processing model (also referred to as a fourth trained machine learning model for image processing) may be a model for an overall optimization of the first image. In some embodiments, the fourth trained machine learning model may include a noise reduction model, an enhancement model, a super-resolution model, a segmentation model, or the like. In some embodiments, the fourth trained machine learning may include a CNN, or the like. In some embodiments, the fourth trained machine learning may also be other models, e.g., a model based on a particular algorithm. In some embodiments, an input to the fourth trained machine learning may be the first image and an output of the fourth trained machine learning may be the sixth image.

In some embodiments, the fourth trained machine learning may be obtained by training a preliminary trained machine learning with a plurality of third training samples each of which has a third training label. In some embodiments, the third training sample may comprise a sample first image, and the third training label may be a sample sixth image corresponding to the sample first image. The sample first image may be a first image of a historical patient. The sample sixth image may be determined based on the first image of the historical patient.

In some embodiments, the processor may determine the target image based on the one or more second images and the sixth image. The processor may multiply each of the one or more second images with a corresponding fusion coefficient and sum a result of the multiplication with the sixth image to obtain the target image.

In some embodiments, the processor may fuse the one or more second images and the sixth image directly using an image fusion algorithm to obtain the target image.

In embodiments of the present disclosure, jointly using the image processing model and the fourth trained machine learning model can enable the image to be optimized to achieve both full optimality and local optimality.

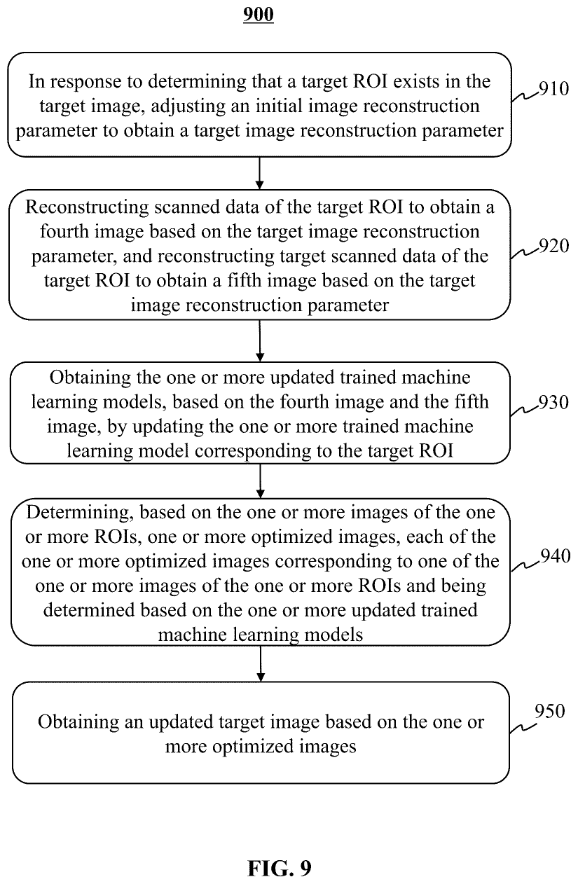

In some embodiments, in response to determining that a target ROI exists in the target image, the processor may adjust the one or more trained machine learning models to obtain one or more updated trained machine learning models. The processor may determine one or more optimized images based on the one or more images of the ROIs, each of the one or more optimized images corresponding to one of the one or more images of the ROIs and being determined based on the one or more updated trained machine learning models. The processor may obtain an updated target image by performing a fusion operation on the one or more optimized images and the target image. More descriptions can be found in FIG. 9 and its related description.

In embodiments of the present disclosure, local optimal optimization can be achieved by a plurality of image processing models optimizing different images of ROIs separately. Meanwhile, replacing a large neural network applicable to multiple tasks with multiple small neural networks for a single task can reduce a requirement for a training dataset, reduce a time for training the neural network, and improve the neural network's stability. Large neural networks require a large amount of data, and a large requirement for data quality, however, an amount of parameters to train a small network is relatively small, and accordingly, an amount of data required is also small. In addition, when a part of the image of the ROI in the first image has a problem or needs to be tuned, only the adjustment of the image processing model corresponding to the organ image that has a problem or needs to be tuned needs to be adjusted, and other regions are not affected, henceforth reducing a waste of resources.

FIG. 5 is a schematic diagram illustrating determining an image processing model according to some embodiments of the present disclosure.

In some embodiments, a processor may determine an image processing model 540 corresponding to an image of a ROI based on at least one of user information 510 or a feature of a ROI 520, as illustrated in FIG. 5.

In some embodiments, as illustrated in FIG. 5, the processor may determine an optimization parameter 530 for the image processing model based on at least one of the user information 510 or the feature of the ROI 520. The processor may further determine an image processing model 540 based on the optimization parameter 530.

In some embodiments, the optimization parameter may be used to determine training data for training the image processing model and/or as an input to the image processing model.

In some embodiments, the optimization parameter may be used as a reconstruction parameter for reconstructing scanned data and/or target scanned data. For example, the first image as described in 410 may be reconstructed based on the optimization parameter.

In some embodiments, the sample first image obtained by reconstructing the scanned data based on the optimization parameter may be used as a first training label for the image processing model, and the sample first image obtained by reconstructing the target scanned data based on the optimization parameter may be used as a first training sample for the image processing model, more descriptions can be referred to FIG. 4 and the related descriptions thereof. By using first images reconstructed with different optimization parameters as first training dataset, an image processing model with different optimization directions may be trained. For an image of an ROI, a plurality of different post-optimization images (i.e., third images) may be obtained by optimizing a plurality of image processing models with different optimization directions.

An image processing model obtained based on training dataset constructed from an optimization parameter may have an optimization direction corresponding to the optimization parameter. In some embodiments, one image processing model may have one optimization direction. An image processing model with a certain optimization direction may make an optimized image optimal in at least one image parameter (e.g., a resolution, a signal-to-noise ratio, an image texture, etc.). For example, an optimization direction of a noise reduction model is noise reduction, which may make an optimized image be optimal in terms of a signal-to-noise ratio; an optimization direction of an enhancement model is enhancement of image texture, which may make an optimized image be optimal in terms of an image texture; and an optimization direction of a super-resolution model is resolution increment, which may make an optimized image be optimal in terms of a resolution. For more information on the optimization direction, please refer to the description below.

In some embodiments, the optimization parameter may be used as the input to the image processing model. In some embodiments, the input to the image processing model may include the image of the ROI of the subject and the optimization parameter, and an output may be the post-optimization image (i.e., the third image) of the optimization parameter corresponding to the optimization direction. For a more detailed description of the third image, please refer to FIG. 6 and its related description.

In some embodiments, the optimization parameter may be determined based on a priori knowledge. For example, ROIs of different types may correspond to different optimization parameters, and a correspondence between the ROIs of different types and the optimization parameters may be determined based on a priori knowledge. The processor may, in turn, determine an optimization parameter for an image of a ROI of a certain type based on the correspondence between the ROIs of different types and the optimization parameters.

In some embodiments, the processor may adjust an image reconstruction parameter and determine an adjusted image reconstruction parameter as the optimization parameter. In some embodiments, the adjusted image reconstruction parameter may cause a reconstructed first image to meet a set requirement. In some embodiments, the set requirement may be determined based on user information. For example, a user's request for an image in the user information may be determined as the set requirement. More descriptions of the user information, please refer to FIG. 4 and its associated description.

In some embodiments, the training dataset determined based on the optimization parameter may be used to update original training dataset.

In some embodiments, a manner of adjusting the image reconstruction parameter may include changing the scatter correction algorithm, changing the point expansion function technique, changing the number of iterations and the number of subsets, or the like. As an example, the scatter correction algorithm may include for example, a threshold-based scattering correction algorithm, a single-scattering simulation-based scattering correction algorithm, an energy-window-based scattering correction algorithm, or the like. However, there is no single algorithm that can satisfy all clinical situations. Therefore, a more effective scatter correction algorithm corresponding to a corresponding site or organ may be selected empirically.

In some embodiments, the optimization parameter may correlate to lesion information. In some embodiments, the processor may determine a candidate parameter of the image of the ROI based on the lesion information; and determine the optimization parameter for the image processing model based on the candidate parameter.

The candidate parameter may be a parameter among a plurality of image parameters that requires further enhancement. For example, the candidate parameter may be any one or more of a resolution, a signal-to-noise ratio, an image texture, or the like. Further description of the lesion information can be found in 420 and its associated description.

In some embodiments, the processor may determine a lesion region based on the lesion information and determine a difference between an image parameter of the lesion region and an image parameter of a surrounding region of the lesion. The processor may further treat an image parameter whose difference in the image parameter of the lesion region and the image parameter of the surrounding region of the lesion is less than a differentiation threshold as the candidate parameter. The differentiation threshold may be a preset threshold for determining whether or not to be used as the candidate parameter. The differentiation threshold may be set empirically.

As an example only, if an image texture difference between the lesion region and the surrounding region of the lesion is small (i.e., not fine enough), it is not conducive for a physician to view a difference between a lesion tissue and surrounding healthy tissues for analysis and diagnosis. Therefore, an image texture may be used as the candidate parameter, so that an image texture of a reconstructed medical image according to the optimization parameter is more detailed and precise, which can better assist doctors in diagnosis.

In some embodiments, for an image of a ROI in which lesion information is present, the processor may adjust at least one optimization parameter to improve the candidate parameter, thereby obtaining the optimization parameter.

In the embodiment of the present disclosure, determining the optimization parameter for the image processing model by means of the lesion information can improve the auxiliary and reference effect of an organ image obtained by optimization of the image processing model for the doctor's treatment and diagnosis.

In some embodiments, the processor may also determine the one or more optimization directions of a plurality of image processing models for the image of the ROI based on a count and type of image processing models corresponding to the image of the ROI; and determine the one or more optimization parameters based on the one or more optimization directions.

The type of image processing models may be classified based on the optimization directions. Image processing models with different optimization directions may be image processing models of different types. For example, an image processing model of a type A focuses on improving an image texture (i.e., an optimization direction of the image processing model of type A is improving the image texture), and the image processing model of a type A focuses on learning variations in the image texture of training dataset when being trained. Therefore, in determining the optimization parameter, the quality of the image texture of a training label determined based on the optimization parameter can be higher, so as to improve the matching of the training dataset to a model.

The optimization direction of the image processing model is an image parameter that the optimization model mainly optimizes. The count and type of image processing models corresponding to the image of the ROI is a count and type of image processing models corresponding to the same image of a ROI. The type may include a type that the image processing model is mainly used to optimize, i.e., the optimization direction of the image processing model.

In some embodiments, the processor may determine the optimization direction of the image processing model based on the type of the image processing model corresponding to the image of the ROI. The processor may further determine a percentage of improvement in the optimization parameter for different image parameters based on a proportion of different optimization directions of the plurality of image processing models. For example, if an image of an ROI corresponds to three image processing models, two of the image processing models may be used to optimize a noise texture, and one of the image processing models may be used to optimize an image resolution. Then, among a plurality of image processing models for a certain image of a ROI, optimization parameters of the image processing models accounting for ⅔ are used to enhance the noise texture of the training dataset, and optimization parameters of the image processing model accounting for ⅓ are used to enhance the image resolution of the training dataset. An optimization parameter for enhancing the noise texture and an optimization parameter for enhancing the image resolution may be determined based on a priori experience.

In embodiments of the present disclosure, the optimization parameter determined based on the count and type of image processing models corresponding to the image of the ROI can be trained to match the data to the model. The image processing model determined by the optimization parameter can be obtained to further improve the optimization quality of the image.

FIG. 6 is a flowchart illustrating an exemplary process for determining a second image according to some embodiments of the present disclosure. In some embodiments, a process 600 may be performed by an image processing system or processor. As shown in FIG. 6, the process 600 includes following operations.

In 610, for each image of a ROI, determining a plurality of image processing models corresponding to the image of the ROI.

More descriptions for determining the plurality of image processing models corresponding to the image of the ROI may be referred to FIG. 4, FIG. 5 and their related descriptions, which will not be repeated here.

In 620, determining a plurality of third images corresponding to the one of the images of the one or more ROIs based on the one or more trained machine learning models. Different third images in the plurality of third images corresponding to different optimization directions.

More information about the third image can be referred to FIG. 4 and its associated descriptions.

In some embodiments, each image of an ROI may correspond to a plurality of image processing models. For each image of an ROI, an image processing model of one type may only optimize one image parameter (e.g., a resolution, a contrast, an image texture, etc.) of the image of the ROI. In some embodiments, the processor may determine a plurality of third images after optimizing each of the image of ROI based on the plurality of image processing models corresponding to the image of the ROI, respectively. The processor may separately input an image of an ROI into the plurality of image processing models corresponding to the ROI, and the plurality of image processing models may separately output the plurality of third images. The plurality of image processing models corresponding to the ROI may optimize different image parameters of the image of the ROI, respectively.

For example, among the plurality of image processing models corresponding to the ROI, an image processing model X may optimize a resolution of the image of the ROI, an image processing model Y may optimize a contrast of the image of the ROI, and an image processing model Z may optimize may optimize an image texture of the image of the ROI. With the image processing model X, the image processing model Y, and the image processing model Z, three third images corresponding to the image of the ROI may be obtained after three image parameters, i.e, the resolution, the contrast, and the image texture are optimized, respectively.

In 630, determining a second image corresponding to the one of the one or more images of the one or more ROIs based on the plurality of third images.

In some embodiments, the processor may perform a weighted fusion on the plurality of third images output by different image processing models to obtain the second image. It should be noted that a manner of fusing the third images is to superimpose the plurality of third images corresponding to the same ROI, and a manner of fusing the second images is to splice the second images of different ROIs, and edges of the second images may overlap. Thus, the manner of fusing the third images to generate the second image may be different from the manner of fusing the second images to generate the target image.

In some embodiments, the processor may identify an optimized image parameter of the plurality of third images; based on the optimized image parameter of the plurality of third images and a target image parameter, determine a fusion weight for each of the plurality of third images; and based on the fusion weight, perform a fusion on the plurality of third images based on the fusion weight for each of the plurality of third images to determine the second image.

In some embodiments, the image parameter may include a signal-to-noise ratio, a resolution, a contrast ratio, an image texture, or the like. More descriptions about the target image parameter may be found in 420 and its related description, which will not be repeated here.

The fusion weight is a weight coefficient for weighted fusion of each of the plurality of third images.

In some embodiments, the processor may construct a fusion weight determination model based on the target image parameter and the optimized image parameter of each of the plurality of third images; and determine the fusion weight based on the fusion weight determination model. The fusion weight determination model may make the target image parameter correlate with the optimized image parameter of the third image.

For example, for the resolution, the fusion weight determination model may be denoted as a resolution in the target image parameter=Σwᵢ×resolution in an optimized image parameter of the i-th third image, and wᵢ is a fusion weight corresponding to the optimized image parameter of the i-th third image. For other optimized image parameters of other third images, a fusion weight determination model of other post-optimization image parameters may also be constructed in a similar manner, and fusion weights of different optimized image parameters of different third images may be obtained after associating and solving.

In some embodiments, the fusion weight may be determined empirically and the fusion weight may range from 0 to 1.

In some embodiments, the processor may superimpose the plurality of third images based on the fusion weight corresponding to each of the plurality of third images to determine the second image.

In embodiments of the present disclosure, determining the fusion weight corresponding to each of the plurality of third images based on the optimized image parameter of the third image and the target image parameter can make the second image obtained by fusion better satisfy the user's needs for image reading.

In some embodiments, the processor may divide each of the plurality of third images into regions; determine fusion weights for different regions based on lesion information and information of surrounding tissues; and perform a fusion based on the fusion weights for the different regions to determine the second image.

More descriptions of the lesion information and information of surrounding tissues can be found in FIG. 4 and its related descriptions.

In some embodiments, the processor may divide each of the plurality of third images based on the lesion information and the information of surrounding tissues. If there is a lesion, peripheral tissue, etc., in the image of the ROI, the processor may divide the region based on the lesion, the surrounding tissues, and other organ regions. For example, the processor may divide a portion of a third image including the lesion into one region, a portion of the third image including the surrounding tissues of the lesion into one region, and a portion of the third image including the other organs into one region.

In some embodiments, the processor may determine different weights for the regions including the lesion and the region including the surrounding tissues, respectively. For example, for the region including the lesion, the processor may increase a weight of the third image with a higher contrast and better image texture to ensure that the lesion is easy to differentiate and observe, and for the region including the surrounding tissues, the processor may increase a weight of the third image with a higher contrast and better resolution so that a user can clearly observe the surrounding tissues when needed.

In some embodiments, the processor may divide each image of the plurality of third images into regions and determine fusion weights for different regions of each third image. In some embodiments, the fusion weights for different regions therein may be different for different third images.

In some embodiments, the processor may determine the second image by superimposing regions in the same position of the plurality of third images (subsequently referred to as third sub-images) based on fusion weights of the regions in the same position of the different third images to obtain multiple superimposed regions, and splicing the multiple superimposed regions to obtain the second image.

In the embodiments of the present disclosure, dividing each third image into regions based on the lesion information and the information of surrounding tissues, and determining the fusion weights for different regions of each third image according to tissue features of different regions in the third image can make the fusion more detailed and ensure that a fused image retains more important information to better meet the user's image reading needs. For example, for a region with a more complex tissue type, a resolution may be increased to avoid overlapping blurring of various tissues.

In the embodiments of the present disclosure, image processing models of different types can only optimize one image parameter (e.g., the resolution, the contrast, the image texture, etc.) of the image of the ROI, however, the fusion of the third images output by the plurality of image processing models can optimize a plurality of, or even all parameters of a first image.

FIG. 7 is a schematic diagram illustrating an image processing model and a fusion model according to some embodiments of the present disclosure.

In some embodiments, a processor may determine a target image 750 by performing a fusion operation through a fusion model 740 based on a plurality of second images 730 as shown in FIG. 7.

The fusion model may be configured to fuse images to obtain a target image. In some embodiments, the fusion model may be a trained machine learning model, e.g., a CNN, DNN, etc. In some embodiments, inputs of the fusion model may include a plurality of second images corresponding to images of ROIs in a first image, and an output of the fusion model may include the target image. In some embodiments, inputs of the fusion model may include a plurality of second images corresponding to images of ROIs in a first image and the first images, and an output of the fusion model may include the target image.

In some embodiments, the fusion model may be obtained by training a plurality of fusion training samples with a fusion training label. In some embodiments, a fusion training sample may include a plurality of sample second images, and the fusion training label of the fusion training sample may be an image obtained by fusing the plurality of sample second images. In some embodiments, a fusion training sample may include a plurality of sample second images and sample first image. The fusion training sample may be determined based on a plurality of second images of a historical patient. The fusion training label may be a target image of the historical patient generated by fusing the plurality of sample second image. The fusion model may be constructed based on a CNN model or a DNN model, etc.

In some embodiments, an output of an image processing model may be used as the input to the fusion model. As shown in FIG. 7, image processing models 720-1, . . . , 720-n may process images of ROIs 710-1, . . . , 710-n, respectively, to obtain second images 730-1, . . . , 730-n, and the second images 730-1, . . . , 730-n may be used as an input to a fusion model 740, and an output of the fusion model 740 is a target image 750.

In some embodiments, the fusion model may be obtained by joint training with the image processing model. The processor may input sample first images corresponding to different images of ROIs as training samples into a plurality of preliminary image processing models, respectively, so as to obtain the second image output by each of the preliminary image processing model. The processor may further input second images output by the plurality of initial image processing models into the initial fusion model, so as to obtain a target image output by the preliminary fusion model. The processor may further construct a loss function based on the target image output by the preliminary fusion model and a high-quality image (i.e., the fusion training label), update parameters of the preliminary fusion model based on the loss function, then obtain a trained fusion model.

In the embodiments of the present disclosure, performing the fusion operation on the plurality of second images through the fusion model can utilize the self-learning ability of a machine learning model, so as to find a law from a large amount of historical data, obtain a relationship between the second image and the target image, henceforth improving the quality of image optimization.

FIG. 9 is a flowchart illustrating an exemplary process for determining a target image according to some embodiments of the present disclosure. In some embodiments, a process 900 may be performed by an image processing system or processor. As shown in FIG. 9, the process 900 includes following operations.

In 910, in response to determining that a target ROI exists in the target image, adjusting an initial image reconstruction parameter to obtain a target image reconstruction parameter.

The target image reconstruction parameter may be used to reconstruct the scanned data of a subject to obtain the fourth image.

In some embodiments, the target ROI may be a ROI in the target image whose image quality does not satisfy an image quality condition. The image quality condition may include an image noise being greater than a preset threshold, a presence of image artifacts, a physician's preference for image noise texture, or the like, or a combination thereof.

When reconstructing the scanned data, limitations in an initial image reconstruction parameter result in the presence of ROI in the target image that do not satisfy the image quality condition. For example, organ edge enhancement artifacts, halo artifacts at high uptake sites of the bladder, etc., may be caused by the point spread function (PSF) technique. Adjusting the initial image reconstruction parameter may change parameters in an image reconstruction algorithm, such as changing a count of iterations and a count of subsets, etc. It may also be that other image reconstruction algorithms are used to replace an original image reconstruction algorithm, such as replacing a point expansion function technique using a scattering correction algorithm to make the final obtained target image meet requirements.

In 920, reconstructing scanned data of the target ROI to obtain a fourth image based on the target image reconstruction parameter, and reconstructing target scanned data of the target ROI to obtain a fifth image based on the target image reconstruction parameter. The image quality of the fourth image is higher than the image quality of the fifth image.

More descriptions about the scanned data can be found in FIG. 4 and its related description. The processor may obtain the fourth image using an image reconstruction algorithm.

In 930, obtaining the one or more updated trained machine learning models, based on the fourth image and the fifth image, by updating the one or more trained machine learning model corresponding to the target ROI.

In some embodiments, the processor may obtain a fourth training sample rerated to the target ROI in the fifth image by finding a location corresponding to the target ROI in the fifth image based on a region corresponding to the target ROI in the fourth image, and input the fourth training sample to the image processing model corresponding to the target ROI to obtain the fifth trained machine learning model. The fifth trained machine learning may be a model after optimizing the image processing model. The fifth trained machine learning also refers to the updated trained machine learning model.

In some embodiments, the processor may also train the image processing model corresponding to the target ROI using the fourth training sample of the target ROI in the fourth image to obtain a candidate fifth trained machine learning, and then, based on the fourth training sample of the target organ in the fifth image, train the candidate fifth trained machine learning to obtain the fifth trained machine learning.

In some embodiments, the processor may train the image processing model corresponding to the target organ to obtain the fifth trained machine learning model based on the fourth image and the fifth image. For example, the processor may adjust parameters of the image processing model based on the fourth image and the fifth image to obtain the fifth trained machine learning model. The processor may change a type of the image processing model corresponding to the target ROI, and train an image processing model whose type changes based on the fourth image and the fifth image to obtain the fifth trained machine learning model. For example, if the image processing model corresponding to the target ROI is a U-Net network, the U-Net may be changed to a V-Net or a U-Net++ etc.

In some embodiments, the processor may determine a target image sample corresponding to the target ROI based on the fourth image and the fifth image. The target image sample is an image corresponding to the target ROI in the fifth image.

In some embodiments, the processor may utilize an image recognition algorithm to identify a target ROI in the fourth image and obtain the target ROI; and map the target ROI to the fifth image to obtain the target image sample corresponding to the target ROI. In some embodiments, the processor may also separately identify the target ROI in the fourth image and the fifth image to obtain the target image sample corresponding to the target ROI.

In some embodiments, the processor may train the image processing model corresponding to the target ROI to obtain the fifth trained machine learning based on the target image sample.

In some embodiments, the processor may input the target image sample into the image processing model corresponding to the target ROI, and train a weight of the image processing model until a termination condition is satisfied, so as to obtain the fifth trained machine learning.

In the embodiment of the present disclosure, only the image processing model corresponding to the target ROI needs to be adjusted, and other regions are not affected, which reduces the waste of resources.

In some embodiments, the processor may identify the target ROI in the fourth image; map the target ROI in the fourth image to the fifth image to determine the target image sample of the target ROI from the fifth image.

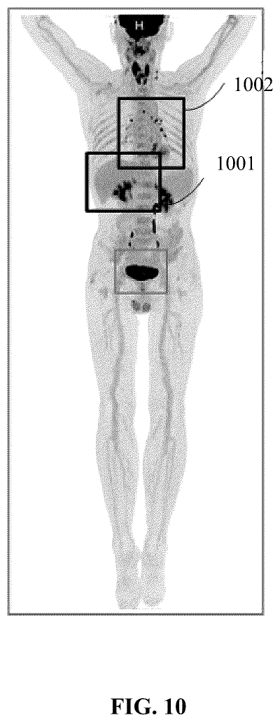

In some embodiments, the target ROI may be one or multiple. The image recognition algorithm is used to recognize the target ROI is located, and a bounding box (e.g., a 2D bounding box or a 3D bounding box) corresponding to the target ROI may be obtained. If there is more than one target ROI, different bounding boxes may overlap. As shown in FIG. 10, a bounding box 1001 is an inspection region corresponding to a liver, and a bounding box 1002 is an inspection region corresponding to the heart.

In some embodiments, the processor may map the target ROI in the fourth image to the fifth image based on location information of the region of the organ image of the target organ, so to determine the target image sample of the target ROI from the fifth image. For example, first coordinates of an upper-left corner of the bounding box corresponding to the liver and second coordinates of a lower-right corner of the bounding box corresponding to the liver are mapped to the fifth image, and a target image sample of the liver may be obtained.

In embodiments of the present disclosure, a model applicable to multiple tasks is replaced by a plurality of single-task image processing models, and only an image processing model corresponding to an ROI that does not satisfy a predetermined image quality condition is required to be trained, which can downgrade a requirement for training samples, reduce a time for training the image processing model, and improve the stability of the image processing model.

In 940, determining, based on the one or more images of the one or more ROIs, one or more optimized images, each of the one or more optimized images corresponding to one of the one or more images of the one or more ROIs and being determined based on the one or more updated trained machine learning models.

In some embodiments, the processor may input the ROI image corresponding to the target ROI into the fifth trained machine learning. For example, an organ image Gⱼ, j=1, 2, . . . , M corresponding to the target organ is input into a retrained fifth trained machine learning, and the fifth trained machine learning may output the optimized image, denoted as Pj. The optimized image is the medical image obtained after the ROI image has been optimized by the fifth trained machine learning.

In 950, obtaining an updated target image based on the one or more optimized images.

In some embodiments, the processor may perform a weighted fusion on the one or more optimized images to obtain the updated target image. In some embodiments, the processor may perform a weighted fusion on the one or more optimized images and the target image to obtain the updated target image. For example, a corresponding fusion coefficient of the one or more optimized images is Wᵢ, i=1, 2, . . . , N, then the one or more optimized images is multiplied by the corresponding fusion coefficient, and summing a result of the multiplication and the target image to obtain the updated target image.

In embodiments of the present disclosure, the image of the target ROI can be optimized such that a determined new target image is of better quality compared to the target image, henceforth improving the quality of an optimized medical image.

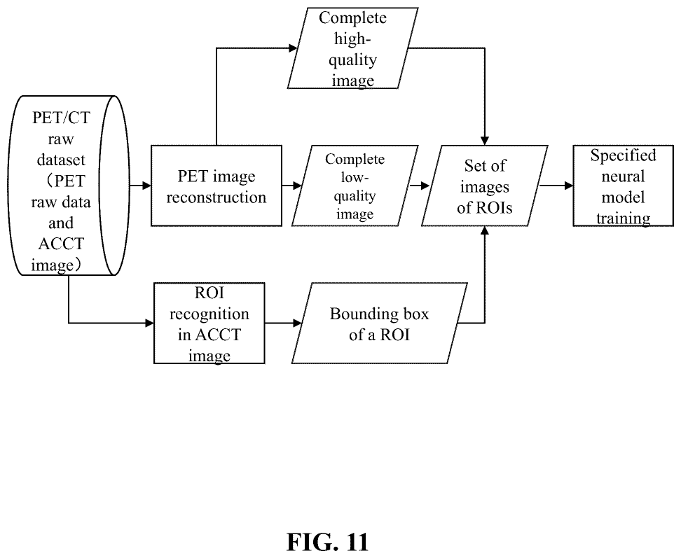

FIG. 11 is a schematic diagram illustrating determining an image processing model according to some embodiments of the present disclosure. As shown in FIG. 11, training the image processing model may include performing image reconstruction on a PET/CT-generated dataset using an image reconstruction algorithm to obtain multiple pairs of complete high-quality images and complete low-quality images (i.e., first images with different image qualities), respectively, determining a set of images of each ROI (training samples of images of each organ) based on each pair of the complete high-quality image and the complete low-quality image, and training a neural network model corresponding to the each ROI according to training samples related to each ROI. Further, since a PET image and an ACCT image are aligned and pixels on the two images have a one-to-one correspondence, an ROI in the ACCT image is recognized, a bounding box of a ROI of the ACCT image is obtained, and the bounding box of the ROI of the ACCT image is mapped to the PET image, so that a set of images of ROIs corresponding to the PET image (i.e., the training samples of the images of each organ) is obtained, and then the neural network model corresponding to image of each organ is trained according to the training samples of the image of each organ.

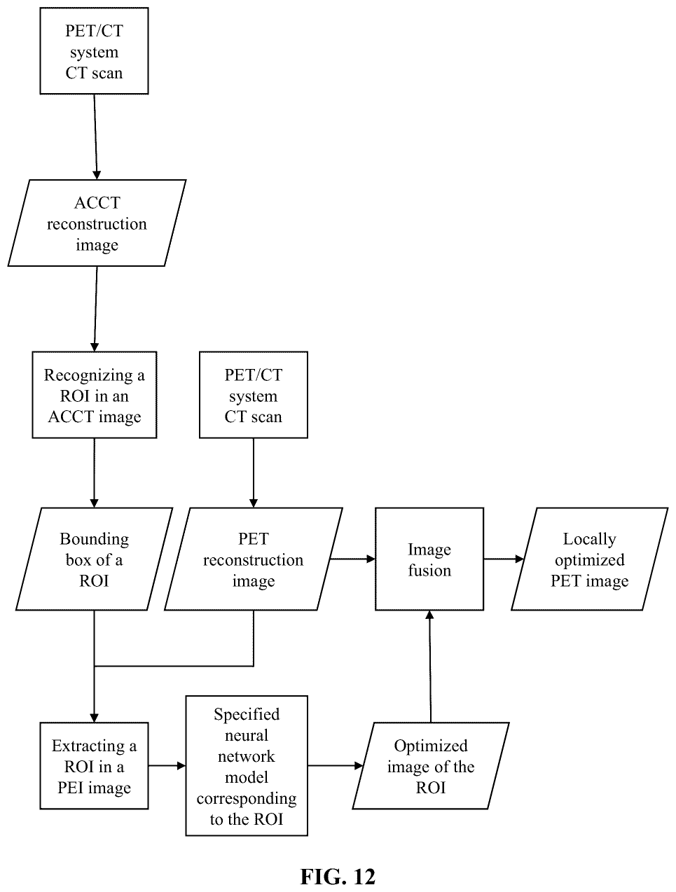

FIG. 12 is a schematic diagram illustrating an image processing method according to some embodiments of the present disclosure. As shown in FIG. 12, following steps are included: performing a CT scan and a PET scan using a PET/CT system, performing an image reconstruction based on raw data obtained from the CT scan, and obtaining an ACCT reconstructed image, performing image reconstruction based on raw data obtained from the PET scan to obtain a PET reconstruction image, and inputting the PET reconstruction image into a corresponding neural network to obtain a fifth image. Recognizing an organ to be optimized in an ACCT reconstructed image, and determining a bounding box of a ROI (i.e., the organ to be optimized), obtaining a PET image corresponding to the organ to be optimized based on the bounding box in the ACCT reconstructed image and the PET reconstructed image, inputting the PET image corresponding to the organ to be optimized into a corresponding neural network model to obtain an optimized image of the ROI (i.e., the first image), fusing the optimized image of the ROI with the fifth image, a locally optimized PET image is obtained (i.e., the target image).

In embodiments of the present disclosure, an image processing device is also provided, comprising at least one processor and at least one memory, the at least one memory being configured to store computer instructions and the at least one processor being configured to execute at least a portion of the computer instructions to implement an image processing method as described in any of the above embodiments.

One or more embodiments of the present disclosure further provide a computer-readable storage medium, the storage medium storing computer instructions, and when a computer reads the computer instructions in the storage medium, the computer performs an image processing method.

Some embodiments of the present disclosure include at least one following beneficial effect: by optimizing different organ images individually by a plurality of image processing models (e.g., optimization models), locally optimal image processing can be achieved. Meanwhile, replacing a large neural network suitable for multi-tasking with a plurality of small neural networks for a single task may reduce a requirement for a training dataset, reduce a time for training the neural network, and improve the neural network's stability. Large neural networks require a large amount of data and a large requirement for data quality, however, an amount of parameters to train a small network is relatively small, and accordingly, an amount of data required may be relatively small. Additionally, when part of an organ image in the first image has a problem or needs to be tuned, it is sufficient to adjust the image processing model corresponding to the organ image that has a problem or needs to be tuned, and the other regions may not be affected, reducing the resource waste.

It should be noted that the foregoing descriptions of the processes 400, 600, and 900 are intended to be exemplary and illustrative only, and do not limit the scope of application of the present disclosure. For a person skilled in the art, various corrections and changes can be made to the processes 400, 600, 900 under the guidance of the present disclosure. However, these corrections and changes remain within the scope of the present disclosure.

The basic concepts have been described above, and it is apparent to those skilled in the art that the foregoing detailed disclosure is intended as an example only and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. Words such as “an embodiment”, “one embodiment”, and/or “some embodiment” mean a feature, structure, or characteristic associated with at least one embodiment of the present disclosure. Accordingly, it should be emphasized and noted that “an embodiment” or “one embodiment”, “an alternative embodiment” referred to two or more times in different locations in the present disclosure means a feature, structure, or characteristic related to at least one embodiment of the present disclosure. In addition, certain features, structures, or characteristics in one or more embodiments of the present disclosure may be suitably combined.

Furthermore, unless expressly stated in the claims, the order of the processing elements and sequences described herein, the use of numerical letters, or the use of other names are not intended to qualify the order of the processes and methods of the present disclosure. While some embodiments of the invention that are currently considered useful are discussed in the foregoing disclosure by way of various examples, it is to be understood that such details serve only illustrative purposes and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the disclosure of the present disclosure, and thereby aid in the understanding of one or more embodiments of the invention, the foregoing descriptions of embodiments of the present disclosure sometimes combine a variety of features into a single embodiment, accompanying drawings, or descriptions thereof. However, this method of disclosure does not imply that more features are required for the objects of the present disclosure than are mentioned in the claims. Rather, claimed subject matter may lie in less than all features of a single foregoing disclosed embodiment.

Some embodiments use numbers to describe the number of components, attributes, and it should be understood that such numbers used in the description of embodiments are modified in some examples by the modifiers “approximately”, “nearly”, or “substantially”. Unless otherwise noted, the terms “nearly,” “approximately,” or “substantially” indicates that a ±20% variation in the stated number is allowed. Correspondingly, in some embodiments, the numerical parameters used in the present disclosure and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, such as articles, books, specification sheets, publications, documents, or the like, are hereby incorporated by reference in their entirety into the present disclosure. Application history documents that are inconsistent with or conflict with the contents of the present disclosure are excluded, as are documents (currently or hereafter appended to the present disclosure) that limit the broadest scope of the claims of the present disclosure. It should be noted that to the extent that there is an inconsistency or conflict between the descriptions, definitions, and/or use of terms in the materials appurtenant to the present disclosure and those set forth herein, the descriptions, definitions and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be considered to be consistent with the teachings of the present disclosure as an example, not as a limitation. Correspondingly, the embodiments of the present disclosure are not limited to the embodiments expressly presented and described herein.

What is claimed is:

1. A method implemented by a computing device including at least a processor and a storage device, comprising:
determining one or more images of one or more regions of interest (ROIs) based on a first image of a subject, each of the one or more images of the one or more ROIs corresponding to one of the one or more ROIs;
determining, based on the one or more images of the one or more ROIs, one or more second images, each of the one or more second images corresponding to one of the one or more images of the one or more ROIs and being determined based on one or more trained machine learning models for image processing corresponding to the one of the one or more images of the one or more ROIs, wherein the image quality of the second image is higher than the image quality of the image of the ROI; and
obtaining a target image of the subject based on the one or more second images.

2. The method of claim 1, wherein different images of ROIs in the one or more images of the one or more ROIs correspond to different regions in the first image, and the different regions partially overlap or the different regions do not overlap.

3. The method of claim 1, wherein different images of ROIs in the one or more images of the one or more ROIs are processed by different trained machine learning models, the different trained machine learning models corresponding to different optimization directions.

4. The method of claim 1, wherein one of the one or more trained machine learning models is obtained by training a preliminary machine learning model according to operations including:
determining a first training dataset based on a plurality of pairs of sample images, each pair of the plurality of pairs of sample images including a sample first image and a sample second image of a sample subject, wherein the image quality of the sample second image is higher than the image quality of the sample first image; and
determining the trained machine learning model by training the preliminary machine learning model based on the first training dataset.

5. The method of claim 1 wherein one of the one or more trained machine learning model includes at least one of a U-Net model, a V-Net model, or a U-Net++ model.

6. The method of claim 1, further comprising:
determining at least one of the one or more trained machine learning models corresponding to the one of the one or more images of the one or more ROIs based on at least one of user information or a feature of the ROI, wherein the feature of the ROI is determined based on the one of the one or more images of the one or more ROIs.

7. The method of claim 1, wherein the determining one or more second images includes:
for one of the one or more images of the one or more ROIs;
determining a plurality of third images corresponding to the one of the one or more images of the one or more ROIs based on the one or more trained machine learning models, different third images in the plurality of third images corresponding to different optimization directions; and
determining a second image corresponding to the one of the one or more images of the one or more ROIs based on the plurality of third images.

8. The method of claim 1, further comprising:
determining an optimization parameter of at least one of the one or more trained machine learning models corresponding to the one of the one or more images of the one or more ROIs based on at least one of user information or a feature of the ROI, the optimization parameter being used to determine training data for training the at least one of the one or more trained machine learning models corresponding to the one of the one or more images of the one or more ROIs and/or as an input to the at least one of the one or more trained machine learning models corresponding to the one of the one or more images of the one or more ROIs.

9. The method of claim 8, wherein the user information includes at least one of a user's primary treatment direction or the user's requirement for the image, and the feature of the ROI includes a type of the ROI, a parameter of an image, or surrounding tissue information of the ROI.

10. The method of claim 1, further comprising:
in response to determining that a target ROI exists in the target image, adjusting the one or more trained machine learning models to obtain one or more updated trained machine learning models;
determining, based on the one or more images of the one or more ROIs, one or more optimized images, each of the one or more optimized images corresponding to one of the one or more images of the one or more ROIs and being determined based on the one or more updated trained machine learning models; and
obtaining an updated target image based on the one or more optimized images.

11. The method of claim 10, wherein the image quality of a portion of the target image corresponding to the target ROI does not satisfy an image quality condition.

12. The method of claim 10, wherein the adjusting the one or more trained machine learning models to obtain one or more updated trained machine learning models includes:
adjusting an initial image reconstruction parameter to obtain a target image reconstruction parameter;
reconstructing scanned data of the target ROI to obtain a fourth image based on the target image reconstruction parameter, and reconstructing target scanned data of the target ROI to obtain a fifth image based on the target image reconstruction parameter, wherein the image quality of the fourth image is higher than the image quality of the fifth image;
obtaining the one or more updated trained machine learning models, based on the fourth image and the fifth image, by updating the one or more trained machine learning model corresponding to the target ROI.

13. The method of claim 10, wherein the adjusting the one or more trained machine learning models to obtain one or more updated trained machine learning models includes:
changing a type of the one or more trained machine learning models corresponding to the target ROI; and
training the one or more trained machine learning models whose type is changed based on the fourth image and the fifth image to obtain the one or more updated trained machine learning models.

14. The method of claim 1, wherein the obtaining a target image of the subject based on the one or more second images includes:
determining the target image by performing a fusion operation on the one or more second images and the first image based on fusion coefficients each of which corresponds to one of the one or more second images.

15. The method of claim 1, wherein the obtaining a target image of the subject based on the one or more second images further includes:
determining the target image by performing a fusion operation on the one or more second images and the first image through a third trained machine learning model.

16. The method of claim 1, further comprising:
determining, based on the first image, a sixth image, the sixth image being determined based on an overall processing model, wherein the overall processing model is a machine learning model; and
obtaining the target image of the subject by performing the fusion operation on the one or more second images and the sixth image.

17. A system implemented by a computing device including at least a processor and a storage device, comprising:
a storage device storing a computer instruction; and
a processor connected to the storage device; and when the computer instruction is executed, the processor causes the system to execute:
determine one or more images of one or more ROIs based on a first image of a subject, each of the one or more images of the one or more ROIs corresponding to one of the one or more ROIs;
determine, based on the one or more images of the one or more ROIs, one or more second images, each of the one or more second images corresponds to one of the one or more images of the one or more ROIs, and is determined based one or more trained machine learning models for image processing corresponding to the one of the one or more images of the one or more ROIs, wherein the image quality of the second image is higher than the image quality of the image of the ROI; and
obtain a target image of the subject based on the one or more second images.

18. The system of claim 17, wherein the processor further causes the system to execute:
in response to determining that a target ROI exists in the target image, adjusting the one or more trained machine learning models to obtain one or more updated trained machine learning models;
determine, based on the images of the one or more ROIs, one or more optimized images, each of the one or more optimized images corresponding to one of the images of the one or more ROIs and being determined based on the one or more updated trained machine learning models; and
obtain an updated target image based on the one or more optimized images.

19. The system of claim 17, wherein the processor further causes the system to execute:
determining, based on the first image, a sixth image, the sixth image being determined based on an overall processing model, wherein the overall processing model is a machine learning model; and
obtain the target image of the subject by performing the fusion operation on the one or more second images and the sixth image.

20. A computer-readable storage medium, wherein the storage medium stores a computer instruction, and when the computer instruction is executed by a processor, a method is implemented, and the method includes:
determining one or more images of one or more ROIs based on a first image of a subject, each of the one or more images of the one or more ROIs corresponding to one of the one or more ROIs;
determining, based on the one or more images of the one or more ROIs, one or more second images, each of the one or more second images corresponding to one of the one or more images of the one or more ROIs, and is determined based one or more trained machine learning models for image processing corresponding to the one of the one or more images of the one or more ROIs; and
obtaining a target image of the subject based on the one or more second images.
